(19) United States
(12) Patent Application Publication
(10) Pub. No.: US 2026/0351032 A1
(43) Pub. Date: Nov. 5, 2026

(54) SYSTEMS AND METHODS FOR AUTOMATED SOURCE DATA OBJECT LINEAGE TRACKING

(71) Applicant: ROYAL BANK OF CANADA, Toronto (CA)

(72) Inventors: Som BANERJEE, Halifax (CA); Rex DAVIS, Prior Lake, MN (US); Muhammad Arham WAQAR, Milton (CA); Shivani CHANDNA, Mississauga (CA); Rani SINGH, Toronto (CA); Arjun DHIMAN, Toronto (CA); Kerry KHOO-FAZARI, Toronto (CA); Yu Shing LAW, Toronto (CA); Rose-Marie PATRICK, Toronto (CA)

(21) Appl. No.: 19/557,850

(22) Filed: Mar. 5, 2026

Related U.S. Application Data
(60) Provisional application No. 63/767,363, filed on Mar. 5, 2025.

(51) Int. Cl. G06V 30/148; G06F 16/583; G06F 40/284

(52) U.S. Cl. CPC G06V 30/153; G06F 16/583; G06F 40/284

(57) ABSTRACT

Systems and methods for automated source data object lineage tracking are proposed that utilize specific improvements in data linking and metadata for providing a specialized computing apparatus that is configured to automate the end-to-end transaction testing process using improved knowledge graph data objects. The knowledge graph interprets complex derived CDEs and their underlying string or textual components, and provides a non-trivial and high complexity mechanism for automated, computer implemented interpretation while reducing hallucination risk.

### CROSS REFERENCE

This application is a non-provisional of, and claims all benefit of and priority to U.S. Provisional Patent Application No. 63/767,363, filed Mar. 5, 2025, entitled “SYSTEMS AND METHODS FOR AUTOMATED SOURCE DATA OBJECT LINEAGE TRACKING”. The entire contents of which are hereby incorporated by reference in their entirety.

### FIELD

Embodiments of the present disclosure relate to the field of computer databases and data object linking, and more specifically, embodiments relate to devices, systems and methods for automated source data object lineage tracking using knowledge graph data objects.

### INTRODUCTION

Organizations are subject to internal, external, and regulatory audits on an ongoing basis. Some audits request specific examples of critical data elements (CDEs) that were used to create various publicly published reports. The process of finding source documents with CDEs and matching them back to reports is known as “Transaction Testing”. A testing process is utilized in the industry that is both error prone and inefficient. This process can yield unexpected expenses that scale up as the volume of transaction increases. For a complex organization, there can be millions of pages of documents, at varying levels of quality, and completeness.

### SUMMARY

Systems and methods for automated source data object lineage tracking are proposed that utilize specific improvements in data linking and metadata for providing a specialized computing apparatus that is configured to automate steps in the end-to-end transaction testing process using knowledge graph data objects. The knowledge graph interprets complex derived CDEs and their underlying string or textual components, and provides a non-trivial and high complexity mechanism for automated, computer implemented interpretation.

More specifically, an approach to improved graph-based reasoning with prompt generation is proposed. A knowledge base data structure is implemented as a knowledge graph comprising nodes representing critical data element identifiers, critical data element values, aliases, source systems, regulatory reports, and derived critical data element formulas, and edges representing relationships.

For a derived critical data element, the knowledge graph stores the sub-data elements and the computational formula relating the sub-data elements to the derived critical data element. For example, a Loan-to-Value ratio node may be linked to sub-data element nodes for collateral value, market price of collateral, haircut component, and outstanding loan amount, together with a formula node specifying the arithmetic relationship among these sub-data elements. During prompt generation, the at least one processor traverses the knowledge graph to identify all aliases and sub-data elements associated with a target critical data element identifier, and generates language model prompts for each alias and sub-data element, thereby narrowing and focusing the language model's extraction scope to improve precision. The knowledge graph is further updated through a feedback loop in which user-validated or user-rejected extraction results are stored as feedback records and used to refine alias mappings and derived-CDE component relationships over time.

The apparatus is a computer implemented system that is configured for automated source data object lineage tracking. The computer implemented system includes at least one processor operating with computer memory and non-transitory data storage maintaining a knowledge base data structure storing structured primary transaction data.

A hierarchical post-processing computing approach using priority weighting is proposed herein, which can be used as a post-processing pipeline that is configured to assigns different priorities to different extraction layers (VQA, vision-OCR key: value, traditional OCR). For example, an output from the vision model key: value pair extraction may be assigned a first priority, an output from the visual question answering process may be assigned a second priority, and an output from the text-token-based OCR process may be assigned a third priority.

The proposed approach is configured to first condense OCR-extracted matches and determines whether each condensed match also exists in the vision model extraction output. Where concordance is found, the system reports with high confidence that the critical data element was found and its value matched. Where no concordance is found, the algorithm cascades to the visual question answering results. The system is configured to further evaluate partial match conditions, including scenarios where only the critical data element identifier is found but the value does not match, or where only the value is found but the identifier is absent, assigning a corresponding confidence or reliability classification to each result. Inconsistencies between extraction modalities are flagged and recorded, enabling audit trail transparency and surfacing potential hallucination events from language model outputs.

The system first receives an image data object representing data to be inserted into the knowledge base data structure, and then generate one or more language model prompts, each language model prompt corresponding to a critical data element identifier, an associated critical data element identifier alias, or a critical data element value. These language model prompts customized or adapted for detecting the presence of the critical data element identifier and any accompanying information, such as a critical data element value of the critical data element identifier. Example identifiers can include specific field types, such as a specific string or variable type. The prompts are useful because in a practical implementation scenario, there can be variance in formatting and structure, and the prompts are useful to account for this variance through the semantic extrapolation capabilities of the language models. The one or more language model prompts are then executed using one or more language models against the image data object to generate structured data objects to be inserted as extended metadata corresponding to the image data object in the knowledge base data structure.

This extended metadata can be stored for later usage during inference or analysis of the critical data element identifier, for example, during an automated audit of a report that was generated using a downstream derivative of the image data object, and the audit requires tracing back to the original primary source documents to assess the accuracy of a derivative output in the report.

A practical example would be a report for a complex company, such as a public company with onerous reporting obligations, where there are potentially millions of primary source documents that contribute to a particular output (e.g., earnings for a quarter or a specific line item). If, during the generation of the audit target critical data element identifier value, there is metadata trails leading back to all of the original image data object primary sources or identifiers, an automated system can trace these “breadcrumbs” to automatically conduct an audit of the primary source document, which allows for improved robustness and integrity. Accordingly, such an automated tool can be coupled with an automated audit pipeline to run these analyses at scale, tracing a subset (or in some embodiments all) of the primary source data for every target field or value, and can generate an output indicating whether such field existed in the primary document, and if so, what the value was.

The system can also include specific optical character recognition processes that are conducted to further improve the integrity of the automated audit process. In this example, the at least one processor is further configured to execute both a first and a second optical character recognition process against the image data object, the first optical character recognition process utilizing a specially configured vision model to conduct the first optical character recognition process, and the second optical character recognition process utilizing a text token extraction approach based on text recognition. This allows for both of these optical character recognition processes to be used in tandem. The first OCR method uses a vision model (e.g., Microsoft Phi 3.5, QWEN 7B) configured to output key: value pairs in JSON format, thereby capturing context, while the second method (PaddleOCR) extracts raw text tokens without context. The dual OCR approach is useful as contextual key: value extraction is technically superior, and the non-contextual OCR is used as a feedback mechanism that effectively serves as a hallucination check.

Once the image documents have been processed and stored into a corresponding data storage, the system is ready for receiving and handling queries. In operation, the system can then receive a query data object relating to a target critical data element identifier and execute the query against the knowledge base data structure storing the structured primary transaction data to identify one or more identifiers corresponding to image data object inserted into the knowledge base indicating whether the target critical data element identifier or a corresponding alias of the target critical data element identifier exists within the image data object.

The generated output is an output data object including identifiers of all image data objects inserted into the knowledge base that are associated with the target critical data element identifier or the corresponding alias of the target critical data element identifier. This can be coupled with a user interface or other output mechanism to render a graphical user interface indicating whether there was sufficient basis in the primary documents for a particular target critical data element identifier or value thereof.

The system is coupled with a processing pipeline, for example, that can also be used during a report/chart generation process to automatically verify the source documents of any derivative output and conduct verification as the report is being generated. Conversely, in another variant, the system can also be used post-hoc during an audit. The at least one processor, during this verification, can receive a target value for a critical data element value corresponding to the target critical data element identifier, and for each image data object inserted into the knowledge base that are associated with the target critical data element identifier or the corresponding alias of the target critical data element identifier, determining whether the critical data element value matches the target value.

The system can be further configured, in a variation with optical image recognition, conduct a determination of whether the critical data element value matches the target value is based on stored outputs of the first and the second optical character recognition process against the image data object. This allows a stronger verification than with output text alone. The first and the second optical character recognition process against the image data object are used for redundant cross validation of the critical data element value. The first and the second optical character recognition process against the image data object can also be used for redundant cross validation of the target critical data element identifier or the corresponding alias of the target critical data element identifier in the image data object in another variation.

In some embodiments, the first optical character recognition process is performed by a vision language model configured to output extracted data in structured key: value pair format, such as JSON, thereby preserving semantic context of extracted values.

For example, the vision language model may output a structured object such as {“End Date”: “2025DEC31”, “Principal Amount”: “$10,000,000”, “Currency”: “USD”}, associating each extracted value with its contextual field identifier. The second optical character recognition process is performed by a text-token-based OCR engine that extracts all text elements from the image data object without preserving semantic relationships between extracted tokens. Images fed into the second OCR engine are pre-processed using layout parsing to separate discrete visual elements such as tables, graphs, and free-text regions prior to extraction. The non-contextual output of the second optical character recognition process serves as a verification layer against the contextual output of the first process, enabling detection of hallucinated or fabricated data in the vision language model output by cross-referencing extracted values against the raw text corpus.

From an output perspective, the output data object is stored as a reliability metric data value associated with a validation of source data object lineage, and can be periodically generated from a metadata traversal. The reliability metric data value can also be embedded or inserted into corresponding reliability metadata of a report data object generated based on the corresponding image data objects so that the output data package already includes source data reliability metric data that any third party can use to externally conduct an augmented audit. The reliability metadata of a report data object can also be used to render a user interface output indicative of an audit reliability of one or more data elements within the report data object.

For practical integration, a corresponding computer system is proposed that can be implemented as a physical computer server or computing appliance that operates in a data center, and is coupled to a messaging bus and associated computer systems. The physical computer system is a special purpose machine that is specifically configured to interoperate with image and text embeddings stored in a vector database. The system is specifically configured for being controlled to conduct similarity searches and a multi-modal RAG process is used to surface the most relevant document pages. The system also avoids reprocessing the same images by checking the database before extraction. There is a practical efficiency gain using the specific multi-modal embedding approach. As a practical example, the at least one processor generates multi-modal embeddings for each image data object, including both image-based embeddings derived from the visual content and text-based embeddings derived from extracted text content, and stores the multi-modal embeddings in a vector database.

The at least one processor is further configured to, prior to executing the one or more language model prompts against a newly received image data object, query the vector database to determine whether the image data object has been previously processed, and if so, retrieve the previously stored extraction results without re-executing the extraction pipeline, thereby avoiding redundant processing of identical image data objects even when different critical data element identifiers are being searched for in successive queries. A retrieval augmented generation process is executed by the one or more language models using the stored embeddings and extraction results in the vector database to enhance matching accuracy between extracted values and truth values stored in systems of record.

As an output, the system can generate one or more intermediate data objects which include a reliability metric that can be embedded into report metadata, providing an automated ability to trace all the way back to primary sources and package that as exportable audit evidence. In some embodiments, the system is configured for traversal back to primary sources for automatic generation of packages of audit evidence. The reliability metric data value is computed based on a degree of concordance among the extraction outputs from the plurality of extraction modalities. For example, the reliability metric may indicate a high reliability when the critical data element value is consistently identified across the vision model extraction, the visual question answering process, and the text-token-based OCR process, and may indicate a lower reliability when the value is found in only one extraction modality or when inconsistencies are detected. The output data object, including the reliability metric data value and identifiers of all associated primary source image data objects, is rendered in an interactive web-based user interface that enables an auditor to visually trace the lineage of each critical data element from the regulatory report back to its originating primary source document. User interactions with the interactive user interface, including acceptance or rejection of presented matches, are captured as feedback records and propagated back to the knowledge base data structure to improve future extraction accuracy.

Another practical implementation variant includes comprising an automated sampling module configured to select a subset of transaction records for automated source data object lineage tracking. The sampling module is configured to apply a combination of stratified sampling based on predefined strata such as valuation brackets, risk-based sampling that biases selection toward transaction records exhibiting higher risk indicators or historical failure trends, and unbiased random sampling. The combined sampling approach enables the system to maximize coverage of high-risk transactions while maintaining statistical representativeness of the overall transaction population.

Corresponding methods and articles of manufacture, such as computer program products (non-transitory computer readable media storing instructions thereon) are contemplated.

### DESCRIPTION OF THE FIGURES

In the figures, embodiments are illustrated by way of example. It is to be expressly understood that the description and figures are only for the purpose of illustration and as an aid to understanding.

Embodiments will now be described, by way of example only, with reference to the attached figures, wherein in the figures:

FIG. 1 is a prior art diagram showing an existing approach for document sourcing.

FIG. 2A is a logical flow diagram showing example steps of a method for automated source data object lineage tracking, according to some embodiments.

FIG. 2B is an example property graph architecture that can be used for the knowledge graph, according to some embodiments.

FIG. 2C shows an example more complicated knowledge graph, where, for instance, the CDE “Maturity Date” may be referenced through multiple field or column names across diverse systems, applications, and databases, reflecting its contextual variability.

FIG. 2D is an example set of CDEs, according to some embodiments.

FIG. 2E is an example transformation logic illustration that is used for contextual modifications, according to some embodiment.

FIG. 2F is a simplified example transformation logic illustration that is used for contextual modifications, according to some embodiment.

FIG. 3 is a pre-processing pipeline flow diagram showing an example of a first stage of a method for automated source data object lineage tracking, according to some embodiments.

FIG. 4 is an extraction flow diagram showing an example of a second stage of a method for automated source data object lineage tracking, according to some embodiments.

FIG. 5 is a post-processing diagram showing an example of a third stage of a method for automated source data object lineage tracking, according to some embodiments.

FIG. 6 is a first sample output of primary source documents automatically identified using automated source data object lineage tracking, according to some embodiments.

FIG. 7A-7B is a second sample output of primary source documents automatically identified using automated source data object lineage tracking, according to some embodiments. FIG. 7A continues to FIG. 7B.

FIG. 8 is a third sample output of primary source documents automatically identified using automated source data object lineage tracking, according to some embodiments.

FIG. 9 is a fourth sample output of primary source documents automatically identified using automated source data object lineage tracking, according to some embodiments.

FIG. 10 is an example computer system diagram showing a system for automated source data object lineage tracking, according to some embodiments.

### DETAILED DESCRIPTION

Systems and methods for automated source data object lineage tracking are proposed that utilize specific improvements in data linking and metadata for providing a specialized computing apparatus that is configured to automate steps in the end-to-end transaction testing process. The systems and methods relate to knowledge graph data structures and specific technical approaches for automated reasoning in a high volume computing facility. Approaches proposed herein are specifically directed to reducing the incidence of hallucination events through improved data structure architectures and data objects. While the improved data structure architectures and data objects may incur a higher storage or efficiency cost due to increased complexity, the reduction in hallucination risk and an increased ability to conduct variant tolerant non-identical matching is a worthwhile technical trade-off.

Approaches to extracting and validating structured data elements from heterogeneous image data objects, including scanned documents, digitally generated documents, and mixed-format multi-page files, suffer from several technical deficiencies. Vision language models, while capable of producing contextually rich structured outputs (e.g., key: value pair associations in JSON format), are susceptible to hallucination events in which the model fabricates or interpolates data values that are not visually present in the image data object.

Conversely, text-token-based optical character recognition (OCR) engines, while resistant to hallucination because they extract only visually present characters, produce flat, uncontextualized token sequences that lack semantic associations between extracted values and their corresponding field identifiers. Neither approach, used in isolation, provides a sufficiently reliable mechanism for verifying whether a target data element identifier and its associated value exist within an image data object. The problem is compounded when the same data element may appear under different identifiers, aliases, or formatting conventions across different source documents, requiring the extraction system to account for terminology variance without sacrificing precision.

The proposed approach addresses these technical deficiencies through a multi-layered computer vision and natural language processing architecture that combines a knowledge graph-driven prompt generation engine, a dual-OCR extraction pipeline, a visual question answering (VQA) subsystem, and a hierarchical, rules-based post-processing reconciliation data process.

The knowledge graph stores data element identifiers, aliases, derived data element formulas, and sub-data element decompositions as nodes and edges, and the at least one processor traverses the knowledge graph during prompt generation to produce targeted, alias-expanded prompts that focus the language models on specific data elements and their known variations.

The dual-OCR extraction pipeline executes both a vision language model configured to output contextual key: value pair extractions and a text-token-based OCR engine that produces hallucination-resistant raw text token sequences, and the outputs of these two processes are cross-referenced during post-processing to detect discrepancies indicative of hallucination events, OCR misreads, or document ambiguities. The hierarchical reconciliation algorithm assigns configurable priority weights to each extraction modality and cascades through sequential evaluation stages, first evaluating concordance between contextual and non-contextual extraction outputs, then cascading to VQA outputs where concordance is not found, and finally evaluating partial match conditions to produce a reliability metric data value reflecting the degree of cross-modality concordance for each validated data element.

In various embodiments, the system further addresses practical challenges arising from the heterogeneous nature of real-world image data objects. A multi-step pre-processing pipeline normalizes input image data objects by performing orientation correction, document type classification (readable, non-readable, or mixed based on embedded text layer detection), resolution adjustment, color and contrast enhancement, and layout parsing that separates discrete structural regions such as tables, graphs, and free-text paragraphs, into independent sub-images for region-specific processing by the extraction models.

This region-specific ingestion improves extraction precision by allowing each model to process structurally homogeneous inputs rather than full-page images containing mixed content types that can confuse contextual extraction. Additionally, multi-modal embeddings, comprising both image-based and text-based vector representations, are generated for each processed image data object and stored in a vector database, enabling similarity-based retrieval that surfaces the most relevant pages from large document collections and avoids redundant reprocessing of previously extracted image data objects.

Variations of the system include embodiments in which the knowledge graph stores derived data element decompositions, wherein a target data element is decomposed into constituent sub-data elements linked by formula nodes, and the processor generates separate extraction prompts for each sub-data element rather than searching for a single computed value.

Other variations include embodiments in which the reconciliation algorithm's priority weights are configurable by an administrator, embodiments in which a retrieval augmented generation (RAG) process leverages stored embeddings and prior extraction results to enhance matching accuracy for complex or ambiguously formatted values (e.g., abbreviated notations, regional date formats, and varying numeric representations), and embodiments in which user feedback records, capturing acceptance or rejection of presented matches, are propagated back to the knowledge graph to refine alias mappings and extraction strategies over successive processing runs, thereby creating a self-improving extraction pipeline.

From a practical standpoint, the technical architecture described herein addresses the problem of extracting and verifying structured data elements from image data objects at scale, where the volume of image data objects may range from hundreds to tens of thousands of pages, each potentially containing multiple data elements of interest under varying identifiers and formats. The dual-OCR cross-validation mechanism directly addresses the technical problem of vision language model hallucination by providing an independent, non-generative verification layer. The knowledge graph-driven prompt expansion addresses the technical problem of terminology variance across heterogeneous source documents by systematically generating alias-based and sub-data element-based prompts without requiring the language model to independently discover these associations. The hierarchical reconciliation data process addresses the technical problem of reconciling conflicting extraction outputs from multiple modalities by applying a structured decision tree with configurable priority weighting, producing a quantified reliability metric rather than a binary match/no-match output. Together, these components provide a mesh-type structured processing pipeline in which each layer supports, augments, and cross-validates the outputs of other layers, yielding extraction and verification results with quantifiable reliability that would not be achievable through any single extraction modality alone.

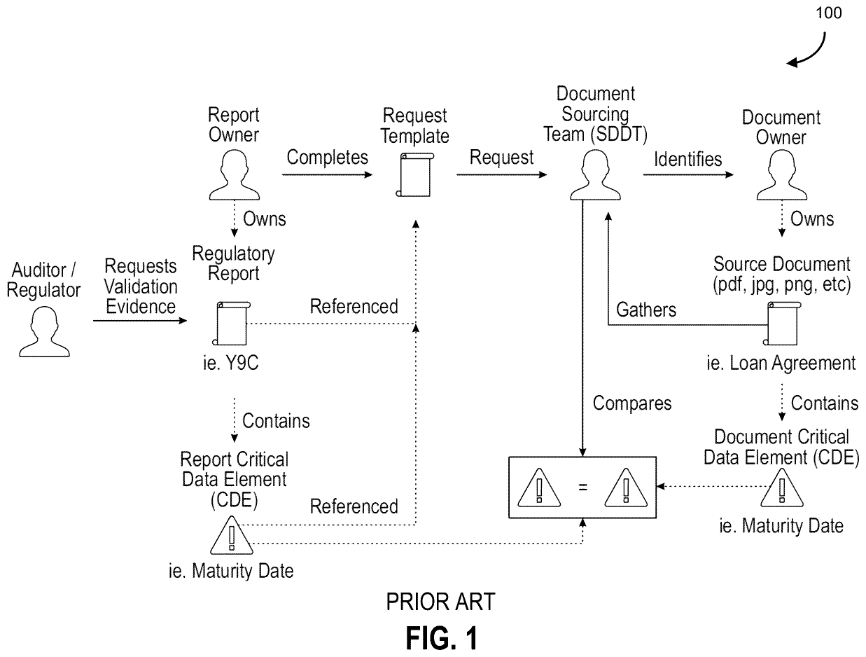

FIG. 1 is a prior art diagram 100 showing an existing approach for document sourcing.

In FIG. 1, the prior approach process steps initiate by having an auditor/regulator selecting a specific report to review. Sample values are selected from the report, report CDEs are identified, and then a request template is completed and sent to SDDT. The SDDT sources all the required documents, and then the SDDT manually confirms report and document CDEs match. The data requested by auditors and regulators can be provided in a template in electronic format. Currently Excel is being leveraged for ease-of-use considerations, but other documents and file formats can be integrated. The process of finding source documents with CDEs and matching them back to reports is known as “Transaction Testing”. A manual testing process is utilized in the industry and is both error prone and inefficient. This process can yield unexpected expenses that scale up as the volume of transaction increases.

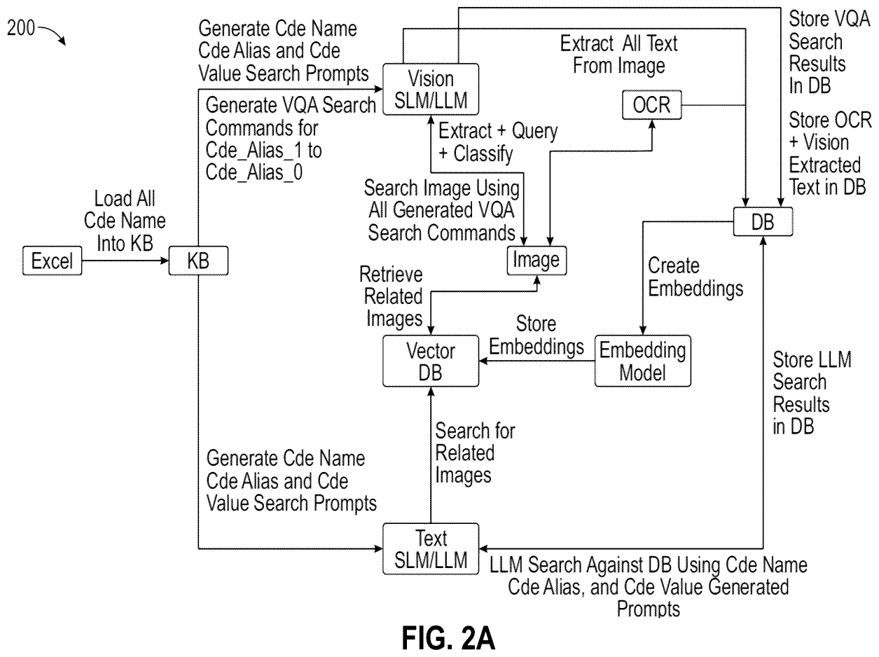

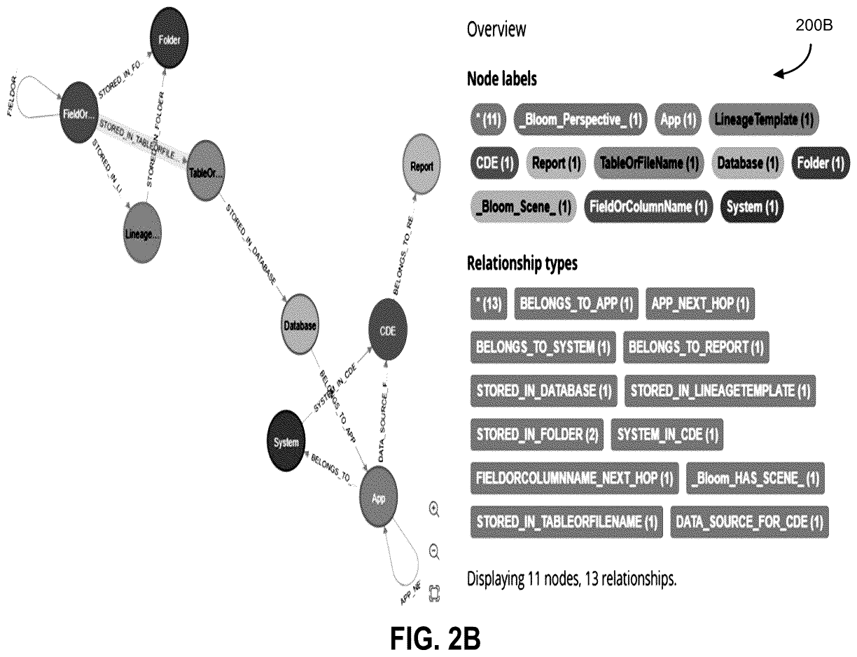

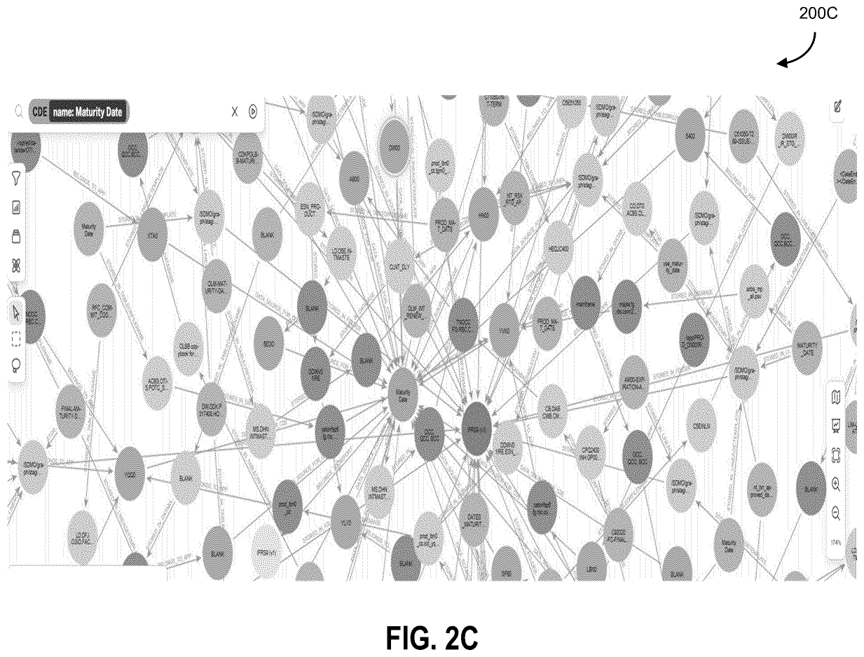

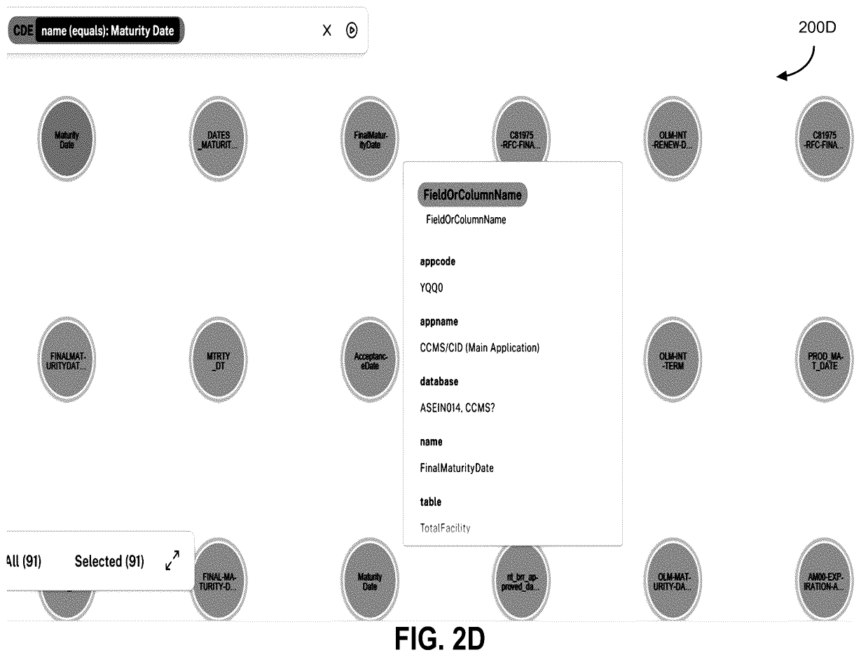

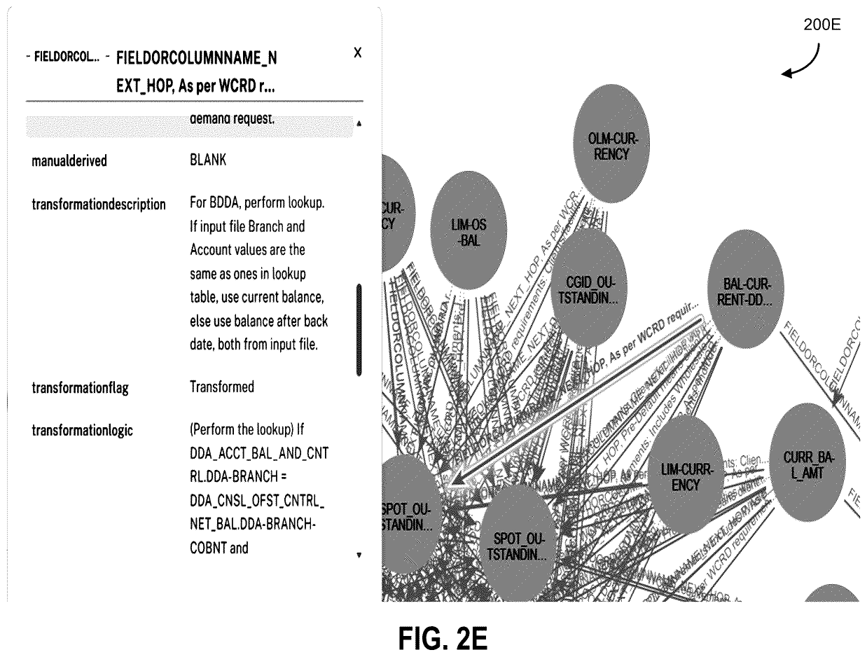

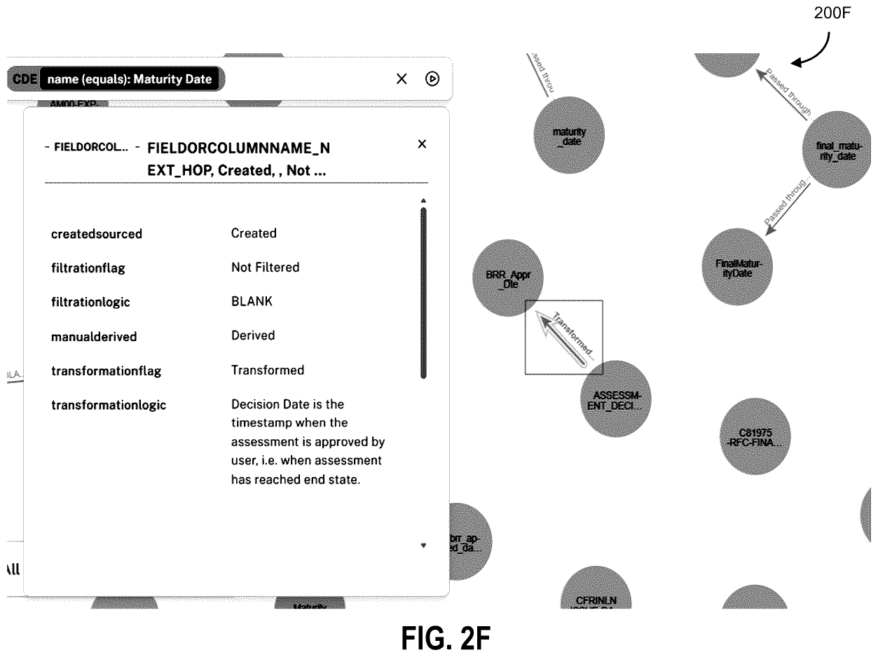

This file serves as the trigger and input to kick off a process 200 as shown in FIG. 2 of a logical flow diagram showing example steps of a method for automated source data object lineage tracking, according to some embodiments.

As shown in FIG. 2, data from the template is ingested and loaded into a database. This portion of the database is known as the “knowledge base” and continues to grow over time. Ingested data is cross-referenced with existing data and elements that need to be searched for (Critical Data Elements, or CDEs) and aliases for these CDEs can be created. A search is executed for not only a CDE, but also for known aliases, improving the overall accuracy of the vision and text based small/large language models (SLMs/LLMs).

Referring now to FIG. 2A, the process 200A for automated source data object lineage tracking is shown, and it relies upon a knowledge base data structure that, in some embodiments, is implemented as a knowledge graph. The knowledge base data structure is maintained by the at least one processor 1002 operating with computer memory 1004 and non-transitory data storage, and stores structured primary transaction data including critical data element (CDE) identifiers, critical data element values, critical data element identifier aliases, source system identifiers, regulatory report identifiers, and derived critical data element formulas. The knowledge graph comprises a plurality of nodes and a plurality of edges connecting the nodes, wherein each node represents one of the foregoing data elements and each edge represents a relationship between two nodes.

Some examples of metadata (properties) associated with Relationships/Edges are:

| Relationship/Edge name | Description | Property/Metadata (Key) | Description |
|---|---|---|---|
| FIELDORCOLUMNNAME_NEXT_HOP | This relationship | Transformationflag | Indicates whether |
| | links two Field or | | Transformation |
| | Column nodes, and | | occurs during |
| | indicates the | | the data transfer |
| | direction of data | TransformationDescription | If yes, then |
| | transfer from one | | description of |
| | to the other | | the transformation |
| | | TransformationLogic | Pseudo-code or |
| | | | code/script |
| | | | associated with |
| | | | the Transformation |
| | | FiltrationFlag | Indicates whether |
| | | | data gets filtered |
| | | | (i.e. rows or |
| | | | columns are |
| | | | excluded) during |
| | | | data transfer |
| | | FiltrationDescription | If yes, then |
| | | | description of |
| | | | what gets filtered |
| | | FiltrationLogic | Pseudo-code or |
| | | | code/script |
| | | | associated |
| | | | with the filter |

A first node in the knowledge graph represents a critical data element identifier labeled “Maturity Date.” The knowledge graph stores a plurality of alias nodes connected to the first node by alias edges, the alias nodes representing alternative identifiers for the same critical data element. For example, the alias nodes may include an alias node for “End Date,” an alias node for “Finish Date,” and an alias node for “Final Date.”

During prompt generation, the system traverses the alias edges from the first node to identify all alias nodes and generates a corresponding language model prompt for each alias. In this example, the system generates a first prompt “Does Maturity Date exist in the image?”, a second prompt “Does End Date exist in the image?”, a third prompt “Does Finish Date exist in the image?”, and a fourth prompt “Does Final Date exist in the image?”, thereby expanding the search scope to account for variance in how the critical data element identifier may appear in different primary source documents.

For derived critical data elements, the knowledge graph stores not only the derived critical data element identifier but also a set of sub-data element nodes and a formula node specifying the arithmetic or logical relationship among the sub-data elements. By way of an example, consider a derived critical data element identifier “Loan-to-Value Ratio” (the “LTV CDE”). The knowledge graph stores a first sub-data element node for “Outstanding Loan Amount,” a second sub-data element node for “Collateral Market Value,” a third sub-data element node for “Haircut Component,” and a fourth sub-data element node for “Collateral Quality Classification.” A formula node is connected to each of these sub-data element nodes and to the LTV CDE node by formula edges, and stores an expression such as: LTV=Outstanding Loan Amount/(Collateral Market Value×(1−Haircut Component)).

During prompt generation for the LTV CDE, the system traverses the knowledge graph from the LTV CDE node along the formula edges to identify each sub-data element node. The system then generates a separate set of language model prompts for each sub-data element. For instance, the system generates prompts including “What is the Outstanding Loan Amount?”, “What is the Collateral Market Value?”, “What is the Haircut Component?”, and “What is the Collateral Quality Classification?” In this manner, the system decomposes the derived critical data element into its constituent sub-data elements and validates each constituent independently, rather than attempting to locate a single computed ratio value in the primary source document.

The knowledge base is a data structure that, for example, could include the following illustrative example structures:

### Critical Data Element (CDE) Aliases

| CDE Name | CDE Value Type | alias 1 | alias 2 | . . . alias n |
|---|---|---|---|---|
| Maturity | Date | End Date | Finish Date | Final Date |
| Date | | | | |

### Components of Derived CDEs:

| CDE Name | sub-DE 1 | sub-DE 2 | . . . sub-DE n | Formula |
|---|---|---|---|---|
| Outstanding | Principal | Interest Rate | Term in Days | a*b + c |
| Amount | Amount | | | |

### Feedback Loop:

| CDE | CDE | | Sample | CDE | Value | User |
|---|---|---|---|---|---|---|
| Name | Value | Report | ID | Found | Found | Accepted |
| Total Value | $100,000,000 | Y9C | RQAT_7 | Tot. Val | $100,000,000 | Yes |
| Domicile | United States | Y9C | RQAT_13 | Country | USA | No |

SLM/LLM prompts are generated based on the CDEs and CDE aliases being searched for. Multiple prompts are generated for each required data element.

Prompt1 is driven by the CDE name, Prompt2 is driven by the CDE Value, and Prompt3 is driven by the combination of the CDE name and CDE value. These prompts are used to ask specific questions of the image being processed, a process known as Visual Question Answering (VQA).

CDE Name and CDE Value are known and captured as structured data. These structured data are used as variables to the process. CDE Name is used to generate structured prompts such as
“Does &cdeName exist in the image?”
“What value can you find for &cdeName?”

The CDE Value is used to generate prompts such as
“Does &cdeValue exist in the image?”
“What is the key associated with &cdeValue where &cdeValue is the value in a key: value pair?”

The structured data are referenced against the Knowledge Base data storage/data structure to identify alternative variables which can also be fed into the process:
For example &cdeName is associated with &alias1, &alias2, . . . , &aliasN
Additional prompts are generated based on aliases
   “Does &alias1 exist in the image?”
   “What value can you find for &alias1?”

In addition to the VQA workflow above, the SLM/LLM is also used to extract all text from the image/document and is used to create a classification based on the type of information in the document/image.

In addition to the SLM/LLM extract above, an optical character recognition (OCR) process is executed against the image/document. Some current generation OCR technologies are capable of maintaining the layout of tables and graphs.

The OCR process serves as a redundant layer to further enhance the performance of the SLMs/LLMs. Two different OCR methods can be used in tandem, in some embodiments. The first leverages the embedded OCR capability within vision models like Microsoft Phi 3.5, QWEN 7B, and other models (e.g., ChatGPT 40 Vision) in the future.

This extract differs from alternative forms of OCR in that the model is configured to provide the output in key: value pairs in JSON format, thus additionally capturing context of the values. The second method utilizes PaddleOCR and is an OCR extract in that it simply extracts all text elements without taking context into consideration, however, images fed into OCR are pre-processed with layout parsing to separate elements like tables and graphs

VQA outputs and SLM/LLM/OCR extractions are loaded into a database. The are embeddings created and associated with the corresponding images. As described herein, a multi-modal RAG process leveraging embedding model(s) is being created. Image and text embeddings will be created and stored in the vector database. LangChain/ColPali can be utilized to surface specific pages of documents most likely to contain the information being searched for.

The LLMs can use the database values in a Retrieval Augmented Generation (RAG) process to further enhance matches between values extracted from the document/image and the known-truth in systems-of-record.

In addition to the RAG process above, the extracted text is converted into embeddings and loaded into a vector database. Doing so allows for similarity searches to be performed against documents/images.

The LLM is configured to search against the database to configure the system to avoid processing the same images multiple times (even if a previous search was looking for different data from that same image). Stage 2 of the process is configured to extract as much information from the image in 2 different ways, according to some embodiments i) Vision (Visual Question Answering+key: value pair Visual-OCR extract), and ii) text token based OCR. With all the required information extracted, the original image is essentially no longer required for the post-processing activities taking place in Stage 3, including for LLM calls.

In a non-limiting example illustrating an example practical implementation of the knowledge graph, consider a regulatory report identified as “Report Y9C” that requires validation of a critical data element identifier “Total Value.” The knowledge graph stores a report node for “Report Y9C” connected by report edges to a CDE node for “Total Value.” The CDE node for “Total Value” is further connected to alias nodes for “Tot. Val” and “Aggregate Value,” and to a value node storing a target value of “$100,000,000.” During a query operation, the system traverses from the report node to the CDE node and then to each alias node, generating prompts for “Total Value,” “Tot. Val,” and “Aggregate Value,” respectively, and further generates a value-based prompt “Does $100,000,000 exist in the image?”

In another example, consider a critical data element identifier “Domicile” with a target value of “United States.” The knowledge graph stores alias nodes for “Country,” “Jurisdiction,” and “Country of Incorporation” connected to the “Domicile” CDE node. The knowledge graph further stores value-alias nodes for “USA,” “US,” and “U.S.A.” connected to the value node for “United States.” During prompt generation, the system generates prompts for each CDE alias and each value alias, resulting in a prompt matrix that includes prompts such as “What is the Country?”, “Does USA exist in the image?”, “What is the Jurisdiction?”, and “Does U.S.A. exist in the image?” This prompt matrix expansion driven by the knowledge graph topology significantly improves recall by accounting for formatting and terminology variations found in heterogeneous primary source documents such as loan agreements, trade confirmations, and settlement statements.

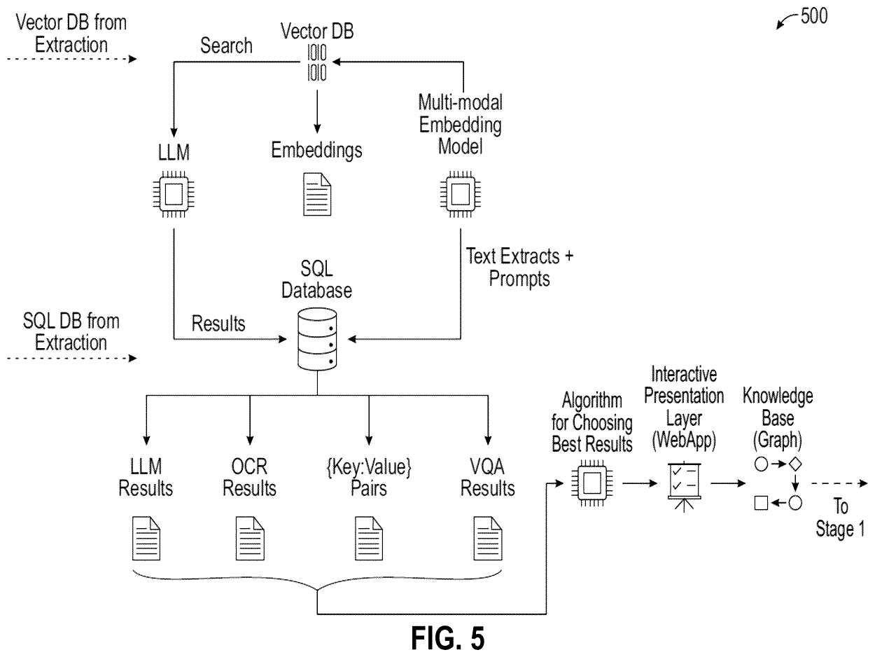

The knowledge graph is further configured to be updated over time through a feedback loop. As described further in greater detail in connection with FIG. 5, user interactions with the interactive web-based user interface generate feedback records. Each feedback record includes a CDE name, a CDE value, a report identifier, a sample identifier, a Boolean indicator of whether the CDE was found, a Boolean indicator of whether the value was found, and a Boolean indicator of whether the user accepted the match. These feedback records are propagated back to the knowledge graph and used to refine alias mappings. For example, if a user repeatedly rejects matches where the alias “Country” was used to locate the CDE “Domicile” in a particular class of source documents (e.g., derivative trade confirmations), the system may adjust the alias weighting or remove the alias association for that document class, thereby improving precision in future extraction runs. Conversely, if a user validates a previously unknown alias, for example, confirming that “Expiry” is a valid alias for “Maturity Date” in a particular source system, the system adds a new alias node and corresponding alias edge to the knowledge graph.

FIG. 2B is an example property graph architecture that can be used for the knowledge graph, according to some embodiments. The property graph architecture 200B was selected for its ability to support flexible, relationship-centric data modeling. This choice addresses the inherent complexity of interdependencies between data entities and aligns with the need for agile schema design and dynamic data representation. Property graphs such as those shown in 200B enable the direct attachment of key-value pairs (properties) to both nodes and edges, optimizing search functionality, contextual enrichment, and pattern recognition. These capabilities collectively enhance graph traversal, enabling efficient data exploration and analysis. As shown in 200B, the graph's node structure encompasses critical data elements (CDEs), reports, processes, systems, applications, databases, tables, fields, files, folders, risks, controls, and other related entities. Supplementary data, such as transformation, filtration, and calculation logic. is stored as properties, ensuring contextual details remain dynamically accessible.

FIG. 2C shows an example more complicated knowledge graph, where, for instance, the CDE “Maturity Date” may be referenced through multiple field or column names across diverse systems, applications, and databases, reflecting its contextual variability.

Graph traversal capabilities allow navigation through nodes and edges to uncover patterns and structures, facilitating the identification of CDEs within documents or images. Relationships (edges) between nodes enable the generation of context-based aliases, allowing the AI Agent to discover and recognize CDEs even when naming conventions differ across sources.

FIG. 2D is an example set of CDEs, according to some embodiments.

Properties shown in 200D such as transformation logic offer rich context for understanding sub-data elements (Sub DEs) components involved in deriving or determining CDEs. This layered contextualization significantly enhances the AI Agent process' accuracy in detecting CDEs within images and documents and reduce hallucination. The CDE (Maturity Date) is surrounded by aliases (e.g., FinalMaturityDate) and related terms.

FIG. 2E is an example transformation logic illustration that is used for contextual modifications, according to some embodiments. In 200E, transformation logic is automatically generated and used to modify how the knowledge graph can be traversed.

FIG. 2F is a simplified example transformation logic illustration that is used for contextual modifications, according to some embodiment. In 200F, the transformation logic is shown in a simplified example as compared to those in FIG. 2E. An AI Agent data process could use these transformations to accurately identify the CDE in documents, even if it appears under a different name.

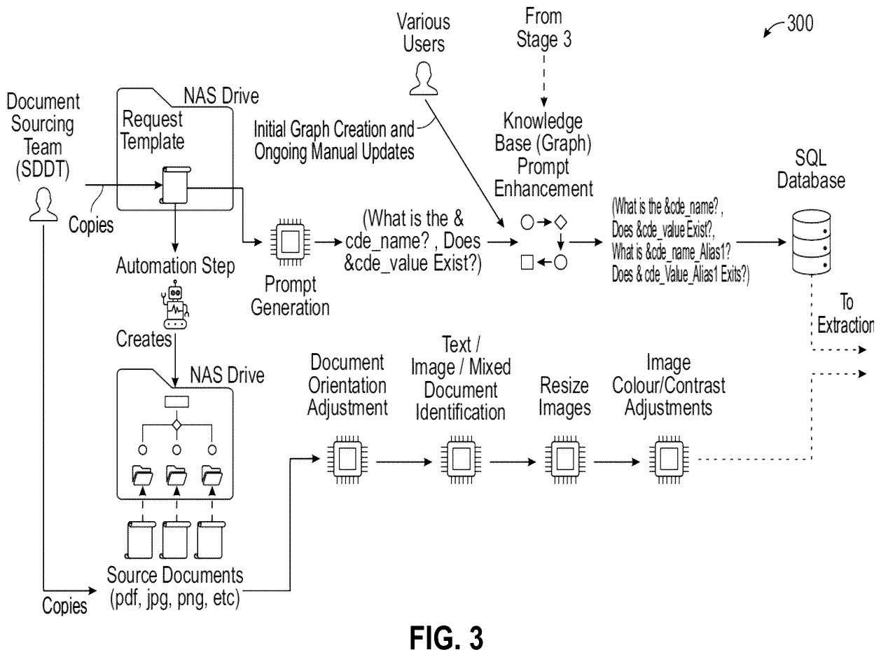

FIG. 3 is a pre-processing pipeline flow diagram showing an example of a first stage 300 of a method for automated source data object lineage tracking, according to some embodiments.

In this example, steps are shown whereby a template is received and first copied to NAS drive to initiate the automation process. A folder structure can be automatically created, and documents are copied to folders. The template data object contains CDE names and values required for search. Visual QA Prompts are generated based on the CDEs and values, and then the document orientation is determined.

A classification process is executed against PDF types to generate classifications (e.g., readable, non, mixed), and images are resized, and color/contrast and other visual adjustments are made.

At the end of this stage, the process begins the extraction stage.

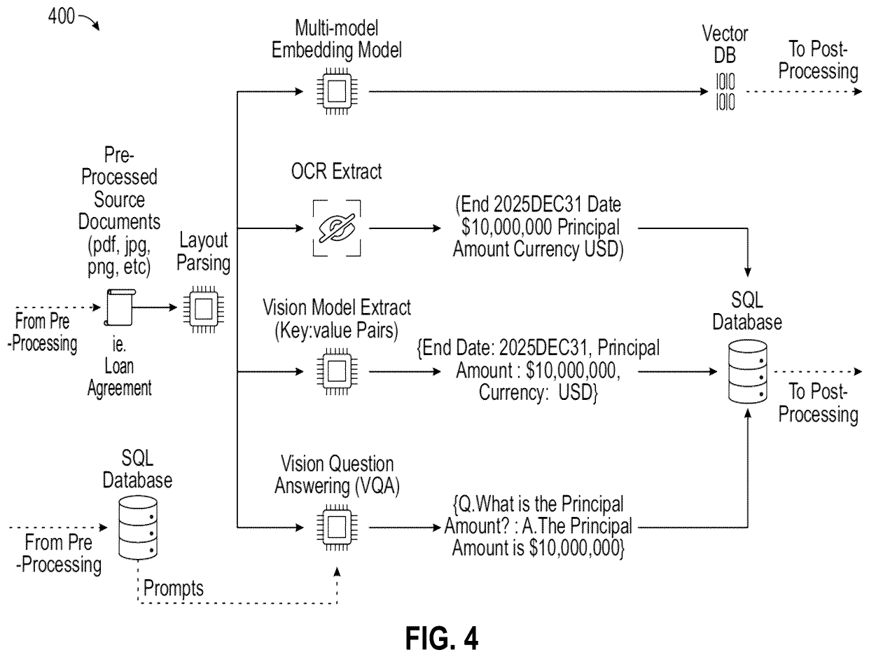

The pre-processing stage 300 of the method for automated source data object lineage tracking includes a multi-step image pre-processing pipeline executed by the at least one processor against each image data object prior to the extraction stage 400 (FIG. 4). The pre-processing pipeline is configured to normalize heterogeneous input documents, which may include PDF files, JPEG images, PNG images, scanned documents, and other image formats, into a standardized form suitable for ingestion by the vision language model and the text-token-based OCR engine.

In a first pre-processing step, the system determines the orientation of the image data object and applies a corrective rotation if the document is detected to be rotated, skewed, or inverted. For example, a scanned loan agreement page that was fed into a scanner upside-down would be rotated 180 degrees; a page scanned at a slight skew angle would be deskewed to align text baselines horizontally. This orientation correction step improves the accuracy of both the vision language model and the text-token-based OCR engine by presenting text in the expected reading orientation.

In a second pre-processing step, the system classifies the image data object into one of a plurality of document type categories based on embedded text layer detection. The categories include: (a) a “readable” type, indicating that the image data object contains an embedded text layer (e.g., a digitally-generated PDF with selectable text); (b) a “non-readable” type, indicating that the image data object does not contain an embedded text layer (e.g., a scanned image with no OCR layer); and (c) a “mixed” type, indicating that some pages of the image data object contain embedded text layers while others do not (e.g., a multi-page PDF in which some pages are digitally generated and others are scanned appendices). This classification informs the extraction stage 400 as to which extraction modalities are likely to produce the highest-fidelity results for a given image data object.

In a non-limiting illustrative example, consider a multi-page image data object representing a credit agreement for a borrower “Northwind Logistics Inc.” Pages 1 through 15 of the credit agreement are digitally generated and contain embedded text layers, while pages 16 through 20 are scanned signature pages and appendices without embedded text layers. The system classifies this image data object as “mixed” type. During the extraction stage 400, the system may apply different processing strategies to the readable pages (e.g., prioritizing embedded text extraction) and the non-readable pages (e.g., relying more heavily on the vision language model and the text-token-based OCR engine for character recognition).

In a third pre-processing step, the system resizes the image data object to a target resolution suitable for ingestion by the vision language model. In some embodiments, the target resolution is selected to balance extraction accuracy against computational efficiency, for example, a resolution sufficient to preserve fine-print text in financial documents while avoiding excessively large image files that would slow model inference.

In a fourth pre-processing step, the system applies color and contrast adjustments to the image data object to improve extraction fidelity. These adjustments may include converting color images to grayscale, increasing contrast between text and background, removing visual noise or artifacts from scanned documents, and adjusting brightness to ensure that faded text is legible. For example, a scanned trade confirmation that was printed on colored paper and exhibits low contrast between text and background would undergo contrast enhancement to sharpen text edges prior to extraction.

In a fifth pre-processing step, the system performs a layout parsing operation against the image data object. The layout parsing operation identifies discrete structural regions within the image data object, such as table regions, graph regions, chart regions, header regions, footer regions, and free-text paragraph regions. Each identified region is separated into a corresponding sub-image, and each sub-image is independently fed to the vision language model and the text-token-based OCR engine during the extraction stage 400.

In a non-limiting example, consider an image data object representing a single page from a settlement statement for a counterparty “Capital Management.” The page contains a free-text header section identifying the counterparty and trade date, a tabular section listing individual line items with columns for “Description,” “Quantity,” “Unit Price,” and “Settlement Amount,” and a bar chart depicting monthly settlement volumes. The layout parsing operation identifies three structural regions: (i) a free-text region corresponding to the header section, (ii) a table region corresponding to the tabular section, and (iii) a graph region corresponding to the bar chart. Each region is extracted as a separate sub-image. The table region sub-image is fed to the vision language model with a system prompt optimized for tabular data extraction (e.g., “Extract all key: value pairs from this table”), while the free-text region sub-image is fed with a prompt optimized for paragraph-level text extraction. The graph region sub-image may be processed separately using a chart interpretation prompt or may be flagged for manual review if chart interpretation is not required for the target critical data elements. This region-specific ingestion improves extraction accuracy by allowing each language model to focus on a structurally homogeneous input rather than a heterogeneous full-page image containing mixed content types.

FIG. 4 is an extraction flow diagram showing an example of a second stage 400 of a method for automated source data object lineage tracking, according to some embodiments. As part of the extraction flow, the document layout is parsed such that embeddings are created and stored in a vector database.

An OCR process is executed which is configured to extract all text for storage in a database. The VLM extracts key: value pairs and stores these values in the database.

VQA Queries are executed based on prompts created in Stage1, and the answers are stored in the database. At the end of this stage, the process begins the post-processing stage.

Referring now to FIG. 4, the extraction stage 400 of the method for automated source data object lineage tracking includes the execution of both a first optical character recognition process and a second optical character recognition process against each image data object. The first optical character recognition process utilizes a specially configured vision language model (VLM), and the second optical character recognition process utilizes a text-token-based OCR engine. These two processes are executed in parallel or in sequence by the system and their respective outputs are stored in the SQL database for use during the post-processing stage 500 (FIG. 5).

The first optical character recognition process is configured to output extracted data in a structured key: value pair format. In some embodiments, the vision language model is instructed, via a system prompt or configuration parameter, to return its extraction output as a JSON object wherein each key represents a contextual field identifier and each value represents the corresponding extracted datum. This contextual extraction preserves the semantic relationship between extracted values and their associated field identifiers, enabling the downstream post-processing stage 500 to directly compare extracted key: value pairs against target critical data element identifiers and values stored in the knowledge base data structure.

Consider an image data object representing a page from a commercial loan agreement for an entity “Acme Manufacturing Corp.” The vision language model processes this image data object and outputs a JSON object such as: {“Borrower”: “Acme Manufacturing Corp.”, “Facility Amount”: “$25,000,000”, “Maturity Date”: “2028-06-30”, “Interest Rate”: “SOFR+2.50%”, “Currency”: “USD”, “Governing Law”: “State of New York”}

In this output, each key (e.g., “Borrower,” “Facility Amount,” “Maturity Date”) provides the contextual field identifier that enables the system to map the extracted value to the corresponding critical data element identifier or alias in the knowledge graph.

The second optical character recognition process is performed by a text-token-based OCR engine that extracts all text elements from the image data object without preserving semantic relationships between extracted tokens. In some embodiments, the text-token-based OCR engine produces a flat sequence of text tokens reflecting all characters recognized in the image data object.

Continuing the non-limiting example of the Acme Manufacturing Corp. loan agreement, the text-token-based OCR engine may produce a token sequence such as:

“COMMERCIAL LOAN AGREEMENT Acme Manufacturing Corp Facility Amount 25,000,000 USD Maturity Date Jun. 30 2028 Interest Rate SOFR 2.50 Governing Law State of New York . . . ”

In this output, the tokens “25,000,000” and “Maturity Date” are extracted as discrete text elements without an inherent association between them. The system must rely on the post-processing reconciliation algorithm (FIG. 5) to associate these tokens with the corresponding critical data element identifiers.

The non-contextual nature of the second optical character recognition process serves a specific technical purpose: it provides a hallucination-resistant verification layer against the contextual output of the first optical character recognition process. Because the text-token-based OCR engine does not employ a language model with generative capabilities, it does not fabricate or interpolate data that is not visually present in the image data object. Accordingly, if the vision language model outputs a key: value pair that includes a value not present anywhere in the text-token-based OCR output, the system flags this discrepancy as a potential hallucination event.

Suppose the vision language model processes an image data object representing a derivative trade confirmation for an example counterparty “GlobalTrade Partners LLC” and outputs a key: value pair {“Notional Amount”: “$50,000,000”}. However, the text-token-based OCR engine, processing the same image data object, extracts the tokens “5,000,000” and “USD” but does not extract the token “50,000,000.” The system detects that the value “$50,000,000” from the VLM extraction does not appear in the OCR text output, while the token “5,000,000” does appear. The system flags this as a potential hallucination as the vision language model may have incorrectly added a leading digit, and records the discrepancy in the inconsistency log for human review. This cross-referencing mechanism directly supports the redundant cross-validation as described in further detail herein. In some embodiments, the vision language model used for the first optical character recognition process is selected from a group including, but not limited to, Microsoft Phi 3.5, QWEN 7B, and multimodal variants of large language models with vision capabilities. The text-token-based OCR engine used for the second optical character recognition process may be, for example, PaddleOCR or another OCR engine optimized for text token extraction without contextual inference. The modular architecture of the extraction stage 400 allows the system to substitute one vision language model for another via an API call.

Referring again to FIG. 4, the extraction stage 400 further includes the generation of multi-modal embeddings by the system. For each image data object processed during the extraction stage 400, the system generates both image-based embeddings derived from the visual content of the image data object and text-based embeddings derived from the text content extracted by the first and second optical character recognition processes. The multi-modal embeddings are stored in a vector database that is distinct from, but communicatively coupled to, the SQL database storing the structured extraction outputs.

In some embodiments, the multi-modal embeddings are generated using an embedding model such as a model in the ColPali family or another multi-modal embedding model capable of producing vector representations from both image and text inputs. The image-based embeddings capture visual features of the image data object, such as layout structure, font characteristics, and graphical elements, while the text-based embeddings capture semantic features of the extracted text content. By storing both embedding types, the vector database enables similarity searches that leverage both visual and semantic similarity, improving the system's ability to surface relevant pages from large document collections.

Consider a large document collection associated with a regulatory report “Report FR-2052a” that requires validation of 150 critical data elements across 2,000 primary source document pages. During the extraction stage 400, the system generates multi-modal embeddings for each of the 2,000 pages and stores them in the vector database. When a query is received for a specific critical data element identifier, for example, “Net Stable Funding Ratio”, the system executes a similarity search against the vector database using a query embedding generated from the text “Net Stable Funding Ratio.” The similarity search returns a ranked list of the document pages most likely to contain information relevant to the “Net Stable Funding Ratio” CDE, based on cosine similarity or another distance metric computed between the query embedding and the stored embeddings. The system then focuses the VQA prompts and the reconciliation algorithm on this ranked subset of pages rather than on the entire 2,000-page collection, thereby reducing computational overhead and improving response time.

The system is further configured to avoid redundant processing of image data objects that have been previously processed during a prior extraction run. Prior to executing the one or more language model prompts against a newly received or newly queried image data object, the system queries the vector database to determine whether a multi-modal embedding for the image data object already exists. If a matching embedding is found, indicating that the image data object was previously processed, the system retrieves the previously stored extraction outputs (including VLM extraction outputs, VQA outputs, and OCR text outputs) from the SQL database without re-executing the extraction pipeline.

This duplicate processing avoidance mechanism provides a significant efficiency improvement in practical deployment scenarios. By way of a non-limiting illustrative example, consider a first query requesting validation of “Maturity Date” across a set of 500 primary source documents. During this first query, the system processes all 500 documents through the full extraction pipeline (stage 400), generating VLM extraction outputs, VQA outputs, OCR text outputs, and multi-modal embeddings for each document, and stores all outputs in the SQL database and vector database. A second query is subsequently received requesting validation of “Principal Amount” across the same set of 500 documents. Rather than reprocessing all 500 documents, the system queries the vector database and determines that embeddings for all 500 documents already exist. The system retrieves the previously stored extraction outputs and executes only the post-processing reconciliation algorithm (stage 500) against the stored data using the new target critical data element identifier “Principal Amount.” This avoids redundant execution of the computationally expensive vision language model and OCR processes, reducing processing time proportionally to the number of previously processed documents.

In some embodiments, a retrieval augmented generation (RAG) process is executed by the one or more language models using the stored embeddings and extraction results in the vector database to enhance matching accuracy. During the RAG process, the system retrieves relevant extraction outputs and embeddings from the vector database and provides them as context to the language model alongside the target critical data element identifier and value. This retrieved context enables the language model to compare extracted values against known-truth values stored in systems of record with greater accuracy, particularly for complex or ambiguous values such as formatted currency amounts (e.g., “$10,000,000.00” vs. “10MM” vs. “10,000 thousands”), date formats (e.g., “2028-06-30” vs. “June 30, 2028” vs. “30/06/2028”), and abbreviated identifiers.

FIG. 5 is a post-processing diagram showing an example of a third stage 500 of a method for automated source data object lineage tracking, according to some embodiments.

Referring now to FIG. 5, the post-processing stage 500 of the method for automated source data object lineage tracking employs a hierarchical, rules-based reconciliation algorithm executed by the system. The reconciliation algorithm operates on extraction outputs stored in a SQL database and a vector database following the extraction stage 400 (FIG. 4). The extraction outputs include, for each image data object: (i) a set of key: value pair outputs from a first optical character recognition process performed by a vision language model (the “VLM extraction outputs”), (ii) a set of answers from a visual question answering (VQA) process (the “VQA outputs”), and (iii) a set of raw text tokens from a second optical character recognition process performed by a text-token-based OCR engine (the “OCR text outputs”).

In some embodiments, the reconciliation algorithm assigns a priority weight to each extraction modality. For example, the VLM extraction outputs may be assigned a first priority (highest), the VQA outputs may be assigned a second priority, and the OCR text outputs may be assigned a third priority. The priority weighting reflects the relative contextual richness of each modality: the VLM extraction outputs preserve semantic context through key: value pair associations, the VQA outputs provide targeted answers to specific prompts, and the OCR text outputs provide an uncontextualized but hallucination-resistant text corpus.

The reconciliation algorithm proceeds through a hierarchical decision tree comprising a plurality of sequential evaluation stages. In a first evaluation stage, the system condenses the OCR text outputs by identifying text tokens that match, either exactly or within a configurable similarity threshold, a target critical data element identifier or a target critical data element value. The system then determines whether each condensed OCR match also exists in the VLM extraction outputs.

In this stage, a LLM is used to generate additional search results from embeddings in the vector database. A rule based, hierarchical algorithm is executed to automatically generate outputs representing decisions as to which matches stored in the DB should be surfaced to users (i.e., if VQA found a value that does not exist in OCR extract, ignore it). The results are then captured into an output data object for rendering/presentment, for example, in an interactive web application to users. In some embodiments, user feedback is collected and used to populate the Knowledge Base (links back to Stage 1).

An example post-processing logical flow can include:
Condense OCR matches and see if an entire match also exists in the Phi Extract
   If yes, good to report CDE found and Value match
   If no, check VQA results
      If yes, good to report CDE found and Value match
      If no, process individual elements
         Does CDE from OCR exist in Phi Extract?
         If yes, report CDE found, value not matched
         If no, check VQA results
         If yes, report CDE found, value not matched
         If no, report CDE not found, value not matched
         Does Value from OCR exist in Phi Extract?
         If yes, report CDE not found, value matched
         If no, check VQA results
         If yes, report CDE not found, value matched
         If no, report CDE not found, value not matched

Images or “documents” are sourced from document owners by the SDDT Team. Document owners are known and tracked in a database owned by SDDT.

By way of a non-limiting illustrative example, consider a target critical data element identifier “Principal Amount” with a target value of “$10,000,000.” During the extraction stage 400, the VLM extraction outputs for a particular image data object include a key: value pair {“Principal Amount”: “$10,000,000”}. The OCR text outputs for the same image data object include the text tokens “Principal,” “Amount,” “$10,000,000,” among other tokens. The system condenses the OCR text outputs to identify a match for both the identifier “Principal Amount” and the value “$10,000,000.” The system then cross-references this condensed match against the VLM extraction outputs and finds concordance, the key: value pair {“Principal Amount”: “$10,000,000”} confirms both the identifier and the value. In this case, the reconciliation algorithm classifies the result as “CDE Found, Value Matched” with a high confidence designation, and the system records this classification in the output data object.

Where the first evaluation stage does not yield concordance, the reconciliation algorithm cascades to a second evaluation stage in which the system evaluates the VQA outputs. Continuing the example, suppose that for a different image data object, the VLM extraction outputs do not contain a key: value pair for “Principal Amount,” but the OCR text outputs contain the text token “$10,000,000” without an associated identifier. The system proceeds to the second evaluation stage and examines the VQA outputs. If the VQA output for the prompt “What is the Principal Amount?” returned an answer of “$10,000,000,” the reconciliation algorithm classifies the result as “CDE Found, Value Matched” with a medium confidence designation, reflecting that the match was confirmed by VQA and OCR but not by the VLM extraction.

The reconciliation algorithm further evaluates a plurality of partial match conditions in a third evaluation stage. These partial match conditions include: (a) the critical data element identifier is found in the OCR text outputs and the VLM extraction outputs, but the associated value does not match the target value, classified as “CDE Found, Value Not Matched”; (b) the critical data element identifier is found in the OCR text outputs but not in the VLM extraction outputs, and the VQA outputs confirm the identifier, classified as “CDE Found, Value Not Matched” with a notation that VLM extraction did not corroborate; (c) the target value is found in the OCR text outputs and the VLM extraction outputs, but the critical data element identifier is not found, classified as “CDE Not Found, Value Matched”; and (d) neither the critical data element identifier nor the target value is found in any extraction modality, classified as “CDE Not Found, Value Not Matched.”

In another example illustrating a partial match scenario, consider a target critical data element identifier “Interest Rate” with a target value of “5.25%.” The VLM extraction outputs for a particular image data object include a key: value pair {“Coupon Rate”: “5.25%”} but do not include a key: value pair with the identifier “Interest Rate.” The OCR text outputs include the token “5.25%” but not the token “Interest Rate.” The VQA output for the prompt “What is the Interest Rate?” returns “5.25%.” In this scenario, the system classifies the result as “CDE Not Found, Value Matched” because the value was confirmed across multiple modalities but the specific identifier “Interest Rate” was not located. The system further generates a flag indicating that the alias “Coupon Rate” may be a candidate alias for “Interest Rate,” and this flag is propagated to the knowledge graph for review and potential incorporation as a new alias node.

Inconsistencies between extraction modalities detected during any evaluation stage are flagged by the system and recorded in an inconsistency log stored in the SQL database. For example, if the VLM extraction outputs report a value of “$10,000,000” for “Principal Amount” but the OCR text outputs contain only the token “$1,000,000” (a discrepancy suggesting a possible hallucination by the vision language model or a misread by the OCR engine), the system records this discrepancy in the inconsistency log together with identifiers of the image data object, the extraction modalities involved, and the specific values in conflict. This inconsistency log enables audit trail transparency, allowing a human reviewer to investigate the root cause of the discrepancy, whether it arose from a hallucination event in the vision language model, a layout parsing error in the OCR engine, or an ambiguity in the source document itself.

In some embodiments, the priority weights assigned to the extraction modalities are configurable and can be adjusted by an administrator through the interactive web-based user interface. For example, if a particular deployment environment consistently produces higher-fidelity results from the VQA process than from the VLM extraction process (e.g., due to the nature of the source documents being predominantly free-text rather than tabular), the administrator may reassign the first priority to the VQA outputs and the second priority to the VLM extraction outputs. The system applies the adjusted priority weights in subsequent execution of the reconciliation algorithm without requiring reprocessing of previously extracted image data objects.

Referring again to FIG. 5, the post-processing stage 500 generates an output data object that includes a reliability metric data value The reliability metric data value is computed by the system based on the degree of concordance among the extraction outputs from the plurality of extraction modalities during the hierarchical reconciliation algorithm.

In some embodiments, the reliability metric data value is expressed as a categorical classification selected from a predefined set of reliability levels. For example, the reliability levels may include: (a) “High Reliability,” assigned when the target critical data element identifier and the target value are both confirmed across all three extraction modalities (VLM extraction, VQA, and OCR text extraction) with full concordance; (b) “Medium Reliability,” assigned when the target critical data element identifier and the target value are confirmed across two of three extraction modalities; (c) “Low Reliability,” assigned when the target critical data element identifier or the target value is confirmed in only one extraction modality; and (d) “No Match,” assigned when neither the target critical data element identifier nor the target value is found in any extraction modality.

By way of a non-limiting example, consider a validation of the critical data element identifier “Outstanding Balance” with a target value of “$75,000,000” against an image data object representing a quarterly statement for an entity “Cedarpoint Financial Holdings.” If the VLM extraction outputs include {“Outstanding Balance”: “$75,000,000”}, the VQA output for the prompt “What is the Outstanding Balance?” returns “$75,000,000,” and the OCR text outputs include the tokens “Outstanding Balance” and “$75,000,000,” the system assigns a “High Reliability” classification to this match. Conversely, if the VLM extraction outputs include {“Outstanding Balance”: “$75,000,000”} but the OCR text outputs include only the token “$75,000” (suggesting a possible truncation) and the VQA output returns “Unable to determine,” the system assigns a “Low Reliability” classification and flags the result for human review.

The reliability metric data value is stored as a component of the output data object associated with the validation of source data object lineage. In some embodiments, the reliability metric data value is inserted into corresponding reliability metadata of a report data object generated based on the corresponding image data objects. This embedding of the reliability metric directly into the report metadata enables any downstream consumer of the report, including internal auditors, external auditors, and regulators, to assess the reliability of each data element in the report without requiring access to the underlying extraction pipeline.

As an example, consider a regulatory report “Report Y9C” generated for a reporting entity “Maplewood Bancshares.” The report includes 50 line items, each corresponding to a critical data element. After the automated source data object lineage tracking process completes, the system inserts a reliability metric data value into the reliability metadata of the report data object for each of the 50 line items. An external auditor reviewing the report can access the reliability metadata and observe, for example, that 42 of the 50 line items received a “High Reliability” classification, 5 received a “Medium Reliability” classification, 2 received a “Low Reliability” classification, and 1 received a “No Match” classification. The auditor can then focus manual review efforts on the 3 items classified as “Low Reliability” or “No Match,” significantly reducing the audit effort compared to a fully manual transaction testing process.

The output data object, including the reliability metric data value and identifiers of all associated primary source image data objects, is rendered in an interactive web-based user interface. The interactive web-based user interface enables an auditor to visually trace the lineage of each critical data element from the regulatory report back to its originating primary source document. In some embodiments, the interactive user interface displays, for each validated critical data element: the critical data element identifier, the target value, the extracted value from each extraction modality, the reliability metric data value, and a hyperlink or visual reference to the specific image data object (and, where applicable, the specific region within the image data object) from which the value was extracted.

User interactions with the interactive user interface are captured as feedback records and propagated back to the knowledge base data structure as described in connection with FIG. 2. In some embodiments, the user may accept or reject each presented match through the interactive user interface. An acceptance feedback record confirms the accuracy of the extraction and the validity of the alias mapping used, while a rejection feedback record triggers a review of the alias mapping and may result in the addition of a new alias node, the removal of an incorrect alias association, or the adjustment of priority weights in the reconciliation algorithm. Over successive extraction runs, this feedback loop progressively refines the knowledge graph and improves the accuracy and reliability of the automated source data object lineage tracking system.

In some embodiments, the computer implemented system for automated source data object lineage tracking further comprises a sampling module executed by the system. The sampling module is configured to select a subset of transaction records from a population of transaction records for processing through the automated source data object lineage tracking pipeline (process 200, FIG. 2).

The sampling module implements a combined sampling methodology that includes three complementary sampling approaches: (i) stratified sampling, (ii) risk-based (biased) sampling, and (iii) unbiased random sampling. The stratified sampling approach divides the population of transaction records into predefined strata based on one or more stratification criteria, such as valuation brackets (e.g., transactions with notional amounts above $50,000,000, between $10,000,000 and $50,000,000, and below $10,000,000), asset class (e.g., fixed income, equities, derivatives), source system, or regulatory report type. A proportional or equal sample is drawn from each stratum to ensure representativeness across the stratification criteria.

The risk-based sampling approach biases the selection toward transaction records that exhibit higher risk indicators or historical failure trends. In some embodiments, the risk-based sampling approach leverages historical feedback records stored in the knowledge base data structure to identify transaction records that are more likely to yield extraction failures or discrepancies. By way of an example, consider a population of 10,000 transaction records for an entity “Ironbridge Capital Corp.” The historical feedback records indicate that transaction records originating from a particular legacy source system, “System LGC-7”, have exhibited a 35% failure rate in prior extraction runs, compared to a 5% failure rate for transaction records originating from a newer source system, “System NXT-2.” The risk-based sampling approach assigns a higher selection probability to transaction records originating from System LGC-7, ensuring that these higher-risk records are disproportionately represented in the sample.

The unbiased random sampling approach provides a baseline sample that is not influenced by stratification criteria or risk indicators. This baseline sample ensures that the overall sample maintains statistical representativeness of the full population and guards against systematic biases that could arise from exclusive reliance on risk-based sampling.

The combined sampling approach merges the samples from the three approaches into a unified sample set. In some embodiments, the system applies configurable weighting parameters to control the relative contribution of each sampling approach to the unified sample set. For example, a configuration may specify that 40% of the unified sample is drawn from the risk-based sampling approach, 40% from the stratified sampling approach, and 20% from the unbiased random sampling approach. By way of an example, if the total desired sample size is 1,000 transaction records, the sampling module would select 400 records via risk-based sampling, 400 records via stratified sampling, and 200 records via unbiased random sampling, with deduplication applied to remove any records that appear in more than one sample.

The sampling module is communicatively coupled to the knowledge base data structure and receives updated historical performance data after each extraction run, allowing the sampling module to adaptively adjust its risk-based selection probabilities over time. For example, if a source system that previously exhibited a high failure rate is upgraded and begins producing higher-fidelity documents, the risk-based selection probability for that source system would decrease in subsequent sampling cycles, reflecting the improved extraction performance. This adaptive feedback mechanism ensures that the sampling strategy remains calibrated to the current state of the document ecosystem rather than being fixed based on historical assumptions.

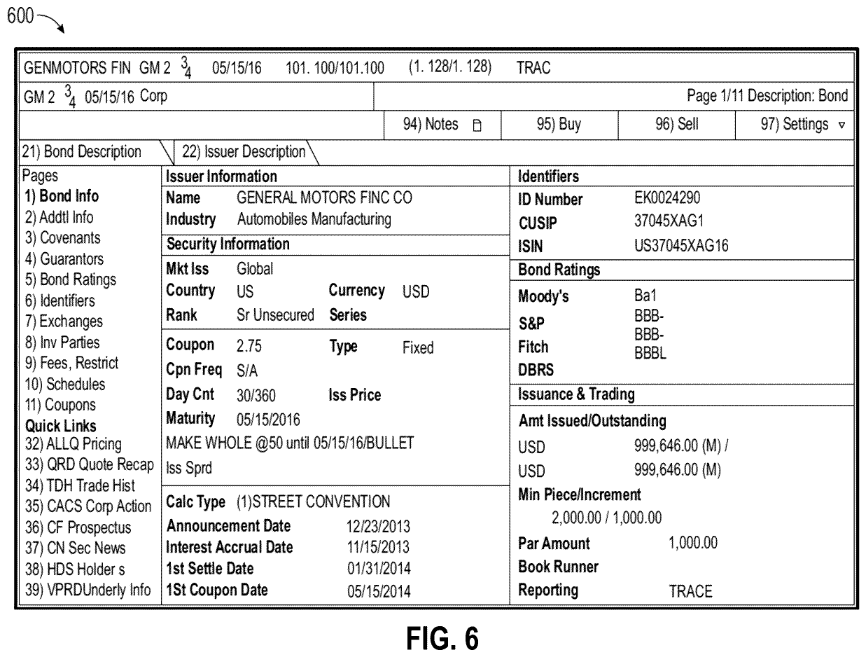

FIG. 6 through FIG. 9 illustrate four sample outputs 600, 700, 800, and 900, respectively, each depicting a different type of primary source document that has been automatically identified and validated using the automated source data object lineage tracking system described herein. Each sample output represents a rendering produced by the interactive web-based user interface, wherein the reliability metadata of a report data object is used to render a user interface output indicative of an audit reliability of one or more data elements within the report data object. The sample outputs 600, 700, 800, and 900 are illustrative of the diversity of primary source document types encountered in a practical deployment of the system, and demonstrate the system's ability to process heterogeneous document formats and content structures through the unified pre-processing pipeline (stage 300, FIG. 3), extraction pipeline (stage 400, FIG. 4), and post-processing reconciliation algorithm (stage 500, FIG. 5).

Across all four sample outputs 600, 700, 800, and 900, the interactive web-based user interface provides a set of common features that support the audit workflow. In some embodiments, each sample output includes a summary header section displaying: the report identifier (e.g., “Report Y9C”), the sample identifier (e.g., “RQAT_7”), the total number of target critical data elements being validated for the sample, the number of validated critical data elements classified as “High Reliability,” “Medium Reliability,” “Low Reliability,” and “No Match,” and an aggregate reliability score computed as a weighted average or percentage of high-reliability matches.

FIG. 6 is a first sample output 600 of primary source documents automatically identified using automated source data object lineage tracking, according to some embodiments. Referring now to FIG. 6, the first sample output 600 depicts a primary source document representing a fixed income instrument description, such as a bond term sheet or offering document. The primary source document includes structured financial data fields such as an issuer identifier, a coupon rate, an instrument type designation (e.g., “Fixed”), a maturity date, a currency denomination, one or more security identifiers (e.g., ISIN or CUSIP), and an exchange listing identifier. The first sample output 600 illustrates a scenario in which the system has executed the full extraction pipeline against the image data object corresponding to this primary source document, and the post-processing reconciliation algorithm has generated output classifications for each target critical data element.

By way of an example corresponding to the first sample output 600, consider a primary source document representing a bond issued by an entity “Meridian Infrastructure Corp.” with the following data fields visible in the document: Issuer: “Meridian Infrastructure Corp.”; Coupon: “4.75%”; Type: “Fixed”; Maturity Date: “2032-09-15”; Currency: “USD”; ISIN: “US59218YAG38”; Exchange: “NYSE”. During the extraction stage 400 (FIG. 4), the vision language model processes this image data object and produces VLM extraction outputs including the key: value pairs {“Issuer”: “Meridian Infrastructure Corp.”, “Coupon”: “4.75%”, “Type”: “Fixed”, “Maturity Date”: “2032-09-15”, “Currency”: “USD”, “ISIN”: “US59218YAG38”}. In parallel, the text-token-based OCR engine extracts the raw text tokens “Meridian,” “Infrastructure,” “Corp,” “4.75%,” “Fixed,” “2032-09-15,” “USD,” “US59218YAG38,” and “NYSE,” among others.

In the post-processing stage 500 (FIG. 5), the system executes the hierarchical reconciliation algorithm against the extraction outputs for the target critical data elements specified in the query. For example, if the query specifies a target critical data element identifier of “Coupon Rate” with a target value of “4.75%,” the system first traverses the knowledge graph (FIG. 2) to identify aliases for “Coupon Rate,” which may include “Coupon,” “Interest Rate,” and “Fixed Rate.” The reconciliation algorithm identifies the key: value pair {“Coupon”: “4.75%”} in the VLM extraction outputs (matched via the alias “Coupon”), confirms the presence of the token “4.75%” in the OCR text outputs, and further confirms the VQA output for the prompt “What is the Coupon Rate?” returns “4.75%.” The reconciliation algorithm classifies this result as “CDE Found, Value Matched” with a “High Reliability” designation. The first sample output 600 rendered in the interactive web-based user interface displays this classification alongside a visual reference to the specific region of the bond term sheet image data object from which the coupon rate value was extracted, enabling the auditor to visually verify the lineage.

The first sample output 600 further illustrates the system's handling of security identifier validation. Security identifiers such as ISIN and CUSIP codes present a particular challenge for extraction systems because they comprise alphanumeric strings that may be misread by OCR engines (e.g., confusing the letter “O” with the digit “0”, or the letter “I” with the digit “1”). The dual-OCR architecture described in Section C addresses this challenge by cross-referencing the VLM extraction output (which benefits from contextual understanding of the field type) against the raw OCR text output (which provides a hallucination-resistant baseline). For example, if the VLM extraction outputs include {“ISIN”: “US59218YAG38”} and the OCR text outputs include the token “US59218YAG38,” the system confirms concordance and assigns a high reliability classification. If, however, the OCR text outputs include the token “US59218YAG38” (with the letter “I” substituted for the digit “1”), the system detects the discrepancy, flags it in the inconsistency log, and assigns a lower reliability classification pending human review.

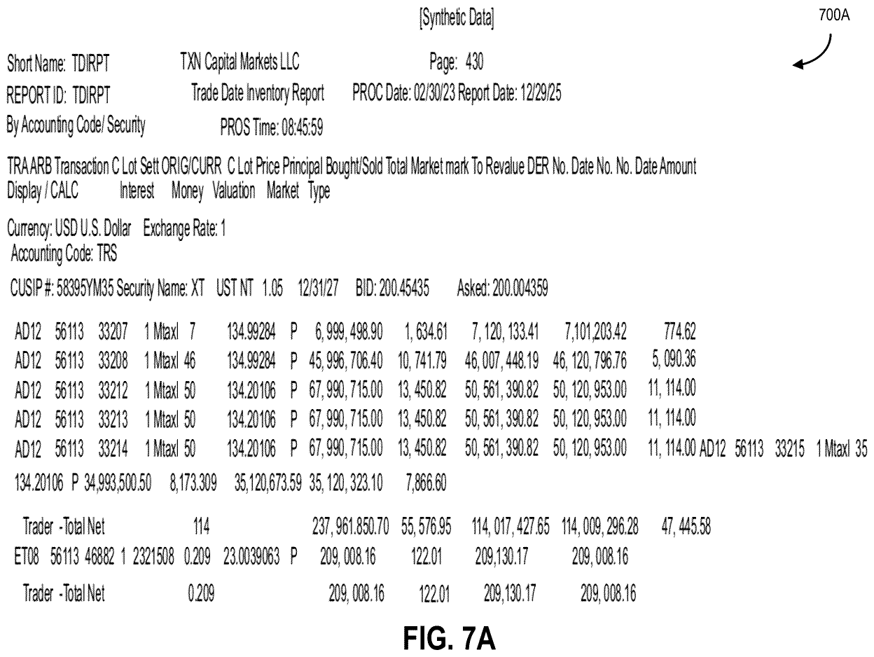

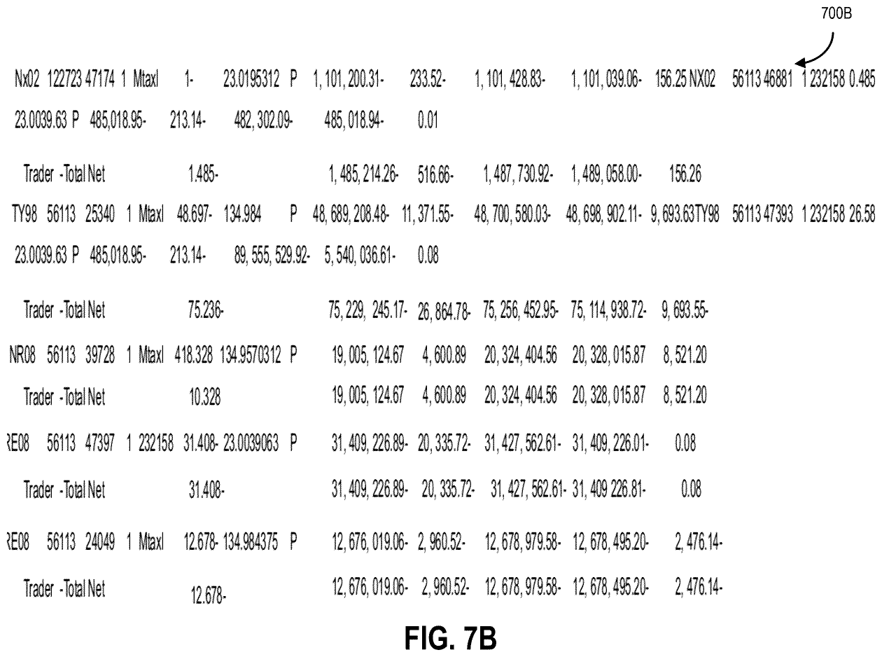

FIG. 7A and FIG. 7B is a second sample output 700A (continued to 700B) of primary source documents automatically identified using automated source data object lineage tracking, according to some embodiments.

Referring now to FIG. 7, the second sample output depicts a primary source document representing a tabular financial data report, such as a portfolio valuation report, a general ledger extract, or a multi-line item regulatory schedule. The primary source document includes a plurality of rows and columns containing financial data such as dates, monetary amounts, account identifiers, and descriptive labels. The second sample output 700 illustrates the system's ability to extract and validate critical data elements from tabular structures where multiple candidate values may exist on the same page.

By way of an example corresponding to the second sample output 700, consider a primary source document representing a quarterly portfolio valuation report for an entity “Ridgeway Asset Management Ltd.” The document contains a table with columns for “Security ID,” “Description,” “Quantity,” “Market Price,” “Market Value,” and “Valuation Date,” and includes 25 rows of individual security holdings. The target critical data element identifier is “Market Value” and the target value is “$31,458,902.67” corresponding to a specific security in the report.

During the pre-processing stage 300 (FIG. 3), the layout parsing operation identifies the tabular region of the image data object and extracts it as a separate sub-image for independent processing. This region-specific extraction is particularly important for tabular documents because the presence of multiple rows with similar formatting and data types increases the risk of the vision language model selecting a value from an incorrect row. By isolating the table region and feeding it to the vision language model with a tabular-optimized system prompt, the system improves the precision of the key: value pair extraction.

The system executes the vision language model against the table sub-image and receives VLM extraction outputs including a set of key: value pairs for each row. The system then identifies the specific row corresponding to the target security and extracts the key: value pair {“Market Value”: “$31,458,902.67”}. The OCR text outputs for the same sub-image include the tokens “$31,458,902.67,” “Market Value,” and numerous other numeric tokens from adjacent rows. The reconciliation algorithm confirms concordance between the VLM extraction output and the OCR text output for the target value, and the VQA output for the prompt “What is the Market Value for [target security]?” returns “$31,458,902.67.” The system assigns a “High Reliability” classification.

The second sample output 700 rendered in the interactive web-based user interface displays the validated result alongside a highlighted visual reference to the specific cell within the table from which the value was extracted. In some embodiments, the interactive user interface renders a bounding box or highlighting overlay on the image data object, identifying the precise location within the table where the target critical data element value was detected. This cell-level visual tracing enables the auditor to verify not only that the correct value was found, but also that it was sourced from the correct row and column within the tabular document, which is critical when multiple similar values exist on the same page.

The second sample output 700 also illustrates the system's handling of scenarios in which multiple candidate values are present in the same document. For example, the portfolio valuation report may contain 25 different “Market Value” entries, one per security holding. The knowledge graph stores not only the target critical data element identifier “Market Value” but also an associated context identifier linking the target value to a specific security (e.g., by Security ID or ISIN). The system uses this contextual association to disambiguate among multiple candidate values and select the correct match. If the system cannot disambiguate (e.g., because the contextual identifier is not found in the document), the output is classified as “CDE Found, Value Matched” with a notation indicating that manual verification of the correct row is recommended.

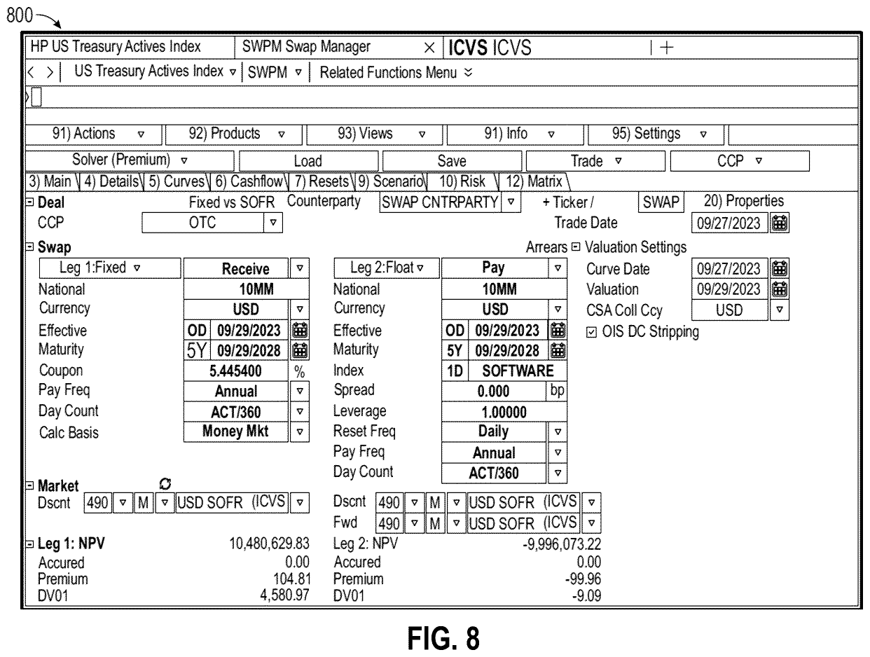

FIG. 8 is a third sample output 800 of primary source documents automatically identified using automated source data object lineage tracking, according to some embodiments.

Referring now to FIG. 8, the third sample output 800 depicts a primary source document representing a trading or valuation record, such as a daily mark-to-market report, a position valuation summary, or a derivative pricing record. The primary source document includes temporal data fields such as valuation dates, settlement dates, and accrual periods, together with numeric data fields such as notional amounts, mark-to-market values, accrued interest, and day count fractions.

By way of an example corresponding to the third sample output 800, consider a primary source document representing a daily mark-to-market report for a portfolio of interest rate swaps managed by an entity “Copperfield Derivatives Desk.” The report includes columns for “Trade ID,” “Counterparty,” “Effective Date,” “Maturity Date,” “Notional Amount,” “Fixed Rate,” “Floating Rate Index,” “MTM Value,” and “Valuation Date.” The target critical data element identifiers for this query include “Notional Amount” with a target value of “$200,000,000” and “MTM Value” with a target value of “−$3,456,789.12” for a specific Trade ID.

The third sample output 800 illustrates several aspects of the system's technical capabilities that are particularly relevant to trading and valuation documents. First, the document contains negative monetary values (e.g., “−$3,456,789.12” for the MTM Value), which present a challenge for OCR engines that may fail to capture the leading negative sign or may interpret it as a hyphen or dash. The dual-OCR architecture addresses this by cross-referencing the VLM extraction output, which, through its contextual understanding, correctly interprets the value as a negative monetary amount, against the raw OCR text output. If the OCR text output extracts the token “3,456,789.12” without the leading negative sign, the system detects the partial discrepancy and classifies the match with a notation indicating that the sign was confirmed by VLM extraction and VQA but not by OCR text extraction.

Second, trading and valuation documents frequently use abbreviated notations for large monetary values (e.g., “200MM” or “200M” in place of “$200,000,000”). The knowledge graph stores value-alias associations for common abbreviation patterns, including “MM” for millions, “M” for thousands (in some conventions) or millions (in other conventions), “BN” for billions, and “K” for thousands. During prompt generation, the system generates prompts for both the full numeric target value “$200,000,000” and the abbreviated forms “200MM” and “$200MM.” The reconciliation algorithm evaluates matches against any of these forms and normalizes the extracted value to a canonical representation for comparison.

Third, the third sample output 800 demonstrates the system's handling of date format variations. The target value for “Valuation Date” may be stored in the knowledge base data structure as “2025-09-30,” but the primary source document may display the date as “30 Sep. 2025,” “September 30, 2025,” “09/30/2025,” or “30/09/2025.” The system applies date normalization logic during the post-processing stage 500 to convert extracted date values into a canonical format before comparison, ensuring that format differences do not result in false negative classifications. The reliability metric data value for the date comparison reflects not only whether the dates match substantively but also whether the format conversion was unambiguous (e.g., “09/30/2025” is unambiguous, whereas “03/09/2025” could be interpreted as either March 9 or September 3 depending on regional convention).

The third sample output 800 rendered in the interactive web-based user interface displays each validated critical data element with its corresponding reliability metric, the extracted values from each extraction modality (VLM, VQA, OCR), and visual references to the specific cells or regions of the mark-to-market report from which the values were sourced. The user interface further displays any inconsistencies detected during reconciliation, enabling the auditor to assess whether a given inconsistency represents a genuine data quality issue or merely a formatting variation.

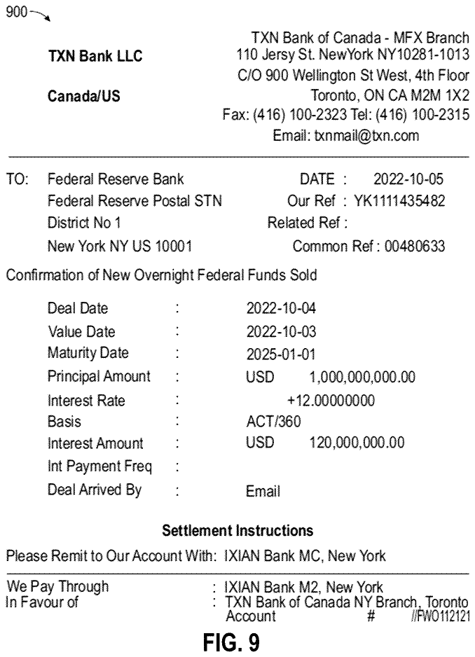

FIG. 9 is a fourth sample output 900 of primary source documents automatically identified using automated source data object lineage tracking, according to some embodiments.

Referring now to FIG. 9, the fourth sample output 900 depicts a primary source document representing a settlement instruction or payment confirmation document, such as a wire transfer instruction, a settlement confirmation letter, or a payment advice. The primary source document includes data fields such as a beneficiary name, a beneficiary address, a bank name, a branch identifier, an account number, a payment amount, a payment currency, a payment date, and reference identifiers.

By way of an example corresponding to the fourth sample output 900, consider a primary source document representing a settlement confirmation for a counterparty “Pinehurst Capital Partners” with the following data fields: Beneficiary: “Pinehurst Capital Partners”; Bank Name: “National Trust Bank of Canada”; Branch: “Bay Street Branch”; Address: “900 Bay Street, Toronto, ON M5S 1Z8”; Account Number: “7291-4583-001”; Settlement Amount: “$120,000,000.00”; Currency: “CAD”; Settlement Date: “2025-10-15”; Reference: “STL-2025-09837.”

The fourth sample output 900 illustrates the system's handling of address and entity name validation, which presents distinct challenges compared to numeric or date validation. Entity names may appear in varying forms across different documents, for example, “National Trust Bank of Canada” may appear as “NT Bank of Canada,” “Nat'l Trust Bank,” or “NTBC” in different source documents. The knowledge graph stores entity name aliases to account for these variations. During prompt generation, the system generates prompts for each known alias of the entity name, and the reconciliation algorithm evaluates matches across all alias forms.

Similarly, account numbers present a specific challenge because they may be formatted differently across documents (e.g., “7291-4583-001” vs. “729145830001” vs. “7291 4583 001”). The system applies a normalization step during the post-processing stage 500 that strips formatting characters (hyphens, spaces, periods) from both the target value and the extracted value before performing the comparison. This normalization ensures that formatting differences in account numbers, reference identifiers, and similar alphanumeric strings do not result in false negative classifications.

The fourth sample output 900 further illustrates the system's handling of multi-field contextual validation. In a settlement instruction document, the settlement amount and the beneficiary are contextually linked, the amount of “$120,000,000.00” is associated with the specific beneficiary “Pinehurst Capital Partners.” If the primary source document contains multiple payment instructions on the same page (e.g., payments to multiple counterparties), the system must not only locate the target settlement amount but also verify that it is associated with the correct beneficiary. The VLM extraction outputs, which preserve key: value pair contextual associations, are particularly valuable in this scenario because they maintain the relationship between the settlement amount and the beneficiary name within the structured JSON output. The OCR text outputs, by contrast, extract the tokens “$120,000,000.00” and “Pinehurst Capital Partners” as discrete elements without an inherent association. The reconciliation algorithm leverages the contextual associations from the VLM extraction outputs to perform multi-field validation, confirming both the individual field values and their contextual relationship to one another.

The fourth sample output 900 rendered in the interactive web-based user interface displays the validated settlement instruction data alongside visual references to the corresponding regions of the settlement confirmation document image. In some embodiments, the interactive user interface renders colored indicators adjacent to each validated field, for example, a green indicator for “High Reliability” matches, a yellow indicator for “Medium Reliability” matches, and a red indicator for “Low Reliability” or “No Match” classifications. The interactive user interface further provides an expandable detail panel for each field, allowing the auditor to view the raw extraction outputs from each modality (VLM, VQA, OCR), the specific reconciliation logic applied, and any inconsistencies detected, thereby providing full transparency into the automated decision-making process.

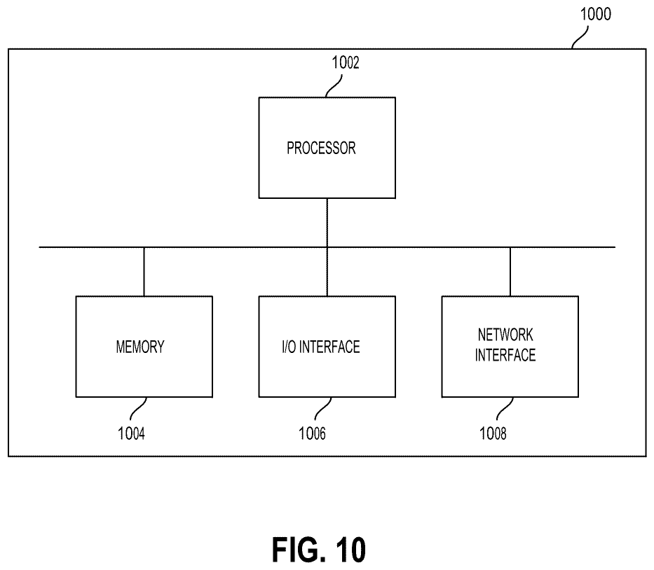

FIG. 10 is an example computer system 1000 for implementing the system for automated source data object lineage tracking, according to some embodiments. As shown in FIG. 10, the system can include a processor 1002, computer memory 1004, an input/output interface 1006, and a network interface 1008.

In some embodiments, the interactive web-based user interface includes a document viewer pane that renders the original image data object alongside the extraction results. The document viewer pane supports zoom, pan, and rotation controls, enabling the auditor to examine fine-grained details of the primary source document. When the auditor selects a specific validated critical data element from the results list, the document viewer pane automatically scrolls to and highlights the region of the image data object from which the value was extracted. In some embodiments, the highlight is rendered as a semi-transparent colored overlay with a bounding box delineating the extracted text region.

In some embodiments, the interactive web-based user interface includes an extraction detail panel that, for each validated critical data element, displays the following information in a structured layout: (a) the target critical data element identifier and any aliases used during the search; (b) the target value from the knowledge base data structure; (c) the VLM extraction output (key: value pair) for the field; (d) the VQA output (answer to the generated prompt) for the field; (e) the OCR text output (raw token match) for the field; (f) the reconciliation classification (e.g., “CDE Found, Value Matched”); (g) the reliability metric data value (e.g., “High Reliability”); and (h) a confidence indicator reflecting the degree of concordance across the three extraction modalities. This extraction detail panel enables the auditor to understand not only the final result but also the reasoning path by which the system arrived at that result, supporting regulatory requirements for explainability and auditability of automated processes.

In some embodiments, the interactive web-based user interface provides accept and reject controls for each validated critical data element. When the auditor selects the accept control, the system records an acceptance feedback record including the critical data element identifier, the critical data element value, the report identifier, the sample identifier, a Boolean “CDE Found” indicator set to true, a Boolean “Value Found” indicator set to true, and a Boolean “User Accepted” indicator set to true. When the auditor selects the reject control, the system records a rejection feedback record with the “User Accepted” indicator set to false, and optionally captures a rejection reason entered by the auditor through a free-text input field. These feedback records are propagated to the knowledge base data structure as described in connection with FIG. 2 above, enabling the system to refine its alias mappings, priority weights, and extraction strategies over time.

In some embodiments, the interactive web-based user interface provides an export function that generates a structured audit evidence package for each sample output. The audit evidence package includes: (a) a summary report listing all validated critical data elements, their target values, extracted values, reliability classifications, and reconciliation outcomes; (b) annotated copies of the primary source document images with highlighted regions corresponding to each extracted value; (c) a detailed extraction log showing the raw outputs from each extraction modality; and (d) the feedback records, if any, recorded by the auditor during the review. This audit evidence package can be provided to internal auditors, external auditors, or regulators as a self-contained body of evidence supporting the lineage validation of the critical data elements, thereby reducing the time and effort required for audit evidence preparation compared to a fully manual transaction testing process.

By way of a non-limiting illustrative example illustrating the end-to-end flow across all four sample outputs, consider a regulatory audit of an example report “Report FR-2052a” generated by a reporting entity “Lakeshore Financial Group.” The auditor initiates a transaction testing query specifying 12 target critical data elements to be validated across 4 sampled primary source documents. The system processes the 4 documents through the automated source data object lineage tracking pipeline and generates the four sample outputs 600, 700, 800, and 900. The first sample output 600 corresponds to a bond term sheet and validates 3 critical data elements (Coupon Rate, Maturity Date, and ISIN) with High Reliability. The second sample output 700 corresponds to a portfolio valuation report and validates 4 critical data elements (Market Value, Quantity, Unit Price, and Valuation Date), of which 3 receive High Reliability and 1 receives Medium Reliability. The third sample output 800 corresponds to a mark-to-market report and validates 3 critical data elements (Notional Amount, MTM Value, and Valuation Date) with High Reliability. The fourth sample output 900 corresponds to a settlement confirmation and validates 2 critical data elements (Settlement Amount and Settlement Date), both with High Reliability. The interactive web-based user interface aggregates the results across all 4 samples and displays a summary dashboard indicating that 11 of 12 critical data elements were validated with High Reliability and 1 with Medium Reliability, yielding an overall aggregate reliability score of 97.9%. The auditor reviews the Medium Reliability result, examines the extraction detail panel, accepts the match after visual verification, and the feedback record is propagated to the knowledge base data structure for future refinement. Existing technologies, including those currently deployed by enterprise scale vendors, do not offer automated transaction testing as a platform, software, or service.

The process proposed herein provides an innovative technical solution that combines multiple technologies to be operated in concert. It utilizes a combination of relational databases, vector databases, optical character recognition, visual (computer vision) question answering models, text based large language models, and computer vision based large and small language models. Each layer helps to support/augment/enhance other layers, essentially creating a mesh-type structured process. The recent advent of Large Language Models (both text and vision based) help to complete a solution that had previously been considered insufficient in this space.

The system is commercially valuable and practically applicable. Transaction testing is a regulatory requirement; it is not an optional activity. As such, it is a time consuming, expensive, and error-prone process to execute manually. The risks are high as there have been recent well publicized cases of other financial institutions facing significant regulatory fines for not having proper processes in place. Automating the transaction testing process aims to reduce the amount of time required to complete the process, allowing the organization to scale with the ever-increasing demand from internal/external/regulatory auditors. There are thousands of transactions to be tested on a yearly basis. Finally, reducing errors in the process will help minimize the risk of significant regulatory fines. However, the automation is non-trivial, and the proposed computational approaches proposed herein along with improved data objects and architectures help improve overall automation efficiency and help address a technical problem associated with hallucination risk.

Applicant notes that the described embodiments and examples are illustrative and non-limiting. Practical implementation of the features may incorporate a combination of some or all of the aspects, and features described herein should not be taken as indications of future or existing product plans. Applicant partakes in both foundational and applied research, and in some cases, the features described are developed on an exploratory basis.

The term “connected” or “coupled to” may include both direct coupling (in which two elements that are coupled to each other contact each other) and indirect coupling (in which at least one additional element is located between the two elements).

Various changes, substitutions and alterations can be made herein without departing from the scope. Moreover, the scope of the present application is not intended to be limited to the particular embodiments of the process, machine, manufacture, composition of matter, means, methods and steps described in the specification.

Processes, machines, manufacture, compositions of matter, means, methods, or steps, presently existing or later to be developed, that perform substantially the same function or achieve substantially the same result as the corresponding embodiments described herein may be utilized. Accordingly, the embodiments are intended to include within their scope such processes, machines, manufacture, compositions of matter, means, methods, or steps.

As can be understood, the examples described above and illustrated are intended to be exemplary only.

What is claimed is:

1. A computer implemented system for automated source data object lineage tracking, the computer implemented system comprising:
at least one processor operating with computer memory and non-transitory data storage maintaining a knowledge base data structure storing structured primary transaction data, the at least one processor configured to:
receive an image data object representing data to be inserted into the knowledge base data structure;
generate one or more language model prompts, each language model prompt corresponding to a critical data element identifier, an associated critical data element identifier alias, or a critical data element value; and
execute the one or more language model prompts using one or more language models against the image data object to generate structured data objects to be inserted as extended metadata corresponding to the image data object in the knowledge base data structure.

2. The computer implemented system of claim 1, wherein the at least one processor is configured to execute both a first and a second optical character recognition process against the image data object, the first optical character recognition process utilizing a specially configured vision model to conduct the first optical character recognition process, and the second optical character recognition process utilizing a text token extraction approach based on text recognition.

3. The computer implemented system of claim 2, wherein the at least one processor is configured to:
receive a query data object relating to a target critical data element identifier;
execute the query against the knowledge base data structure storing the structured primary transaction data to identify one or more identifiers corresponding to image data object inserted into the knowledge base indicating whether the target critical data element identifier or a corresponding alias of the target critical data element identifier exists within the image data object; and
generate an output data object including identifiers of all image data objects inserted into the knowledge base that are associated with the target critical data element identifier or the corresponding alias of the target critical data element identifier.

4. The computer implemented system of claim 3, wherein the at least one processor is configured to:
receive a target value for a critical data element value corresponding to the target critical data element identifier, and for each image data object inserted into the knowledge base that are associated with the target critical data element identifier or the corresponding alias of the target critical data element identifier, determine whether the critical data element value matches the target value.

5. The computer implemented system of claim 4, wherein the determination of whether the critical data element value matches the target value is based on stored outputs of the first and the second optical character recognition process against the image data object.

6. The computer implemented system of claim 5, wherein the first and the second optical character recognition process against the image data object are used for redundant cross validation of the critical data element value.

7. The computer implemented system of claim 5, wherein the first and the second optical character recognition process against the image data object are used for redundant cross validation of the target critical data element identifier or the corresponding alias of the target critical data element identifier in the image data object.

8. The computer implemented system of claim 3, wherein the output data object is stored as a reliability metric data value associated with a validation of source data object lineage.

9. The computer implemented system of claim 8, wherein the reliability metric data value is inserted into corresponding reliability metadata of a report data object generated based on the corresponding image data objects.

10. The computer implemented system of claim 9, wherein the reliability metadata of a report data object is used to render a user interface output indicative of an audit reliability of one or more data elements within the report data object.

11. A computer implemented method for automated source data object lineage tracking, the computer implemented method comprising:
maintaining a knowledge base data structure storing structured primary transaction data;
receiving an image data object representing data to be inserted into the knowledge base data structure;
generating one or more language model prompts, each language model prompt corresponding to a critical data element identifier, an associated critical data element identifier alias, or a critical data element value; and
executing the one or more language model prompts using one or more language models against the image data object to generate structured data objects to be inserted as extended metadata corresponding to the image data object in the knowledge base data structure.

12. The computer implemented method of claim 11, comprising executing both a first and a second optical character recognition process against the image data object, the first optical character recognition process utilizing a specially configured vision model to conduct the first optical character recognition process, and the second optical character recognition process utilizing a text token extraction approach based on text recognition.

13. The computer implemented method of claim 12, comprising
receiving a query data object relating to a target critical data element identifier;
executing the query against the knowledge base data structure storing the structured primary transaction data to identify one or more identifiers corresponding to image data object inserted into the knowledge base indicating whether the target critical data element identifier or a corresponding alias of the target critical data element identifier exists within the image data object; and
generating an output data object including identifiers of all image data objects inserted into the knowledge base that are associated with the target critical data element identifier or the corresponding alias of the target critical data element identifier.

14. The computer implemented method of claim 13, comprising:
receiving a target value for a critical data element value corresponding to the target critical data element identifier, and for each image data object inserted into the knowledge base that are associated with the target critical data element identifier or the corresponding alias of the target critical data element identifier, determine whether the critical data element value matches the target value.

15. The computer implemented method of claim 14, wherein the determination of whether the critical data element value matches the target value is based on stored outputs of the first and the second optical character recognition process against the image data object.

16. The computer implemented method of claim 15, wherein the first and the second optical character recognition process against the image data object are used for redundant cross validation of the critical data element value.

17. The computer implemented method of claim 15, wherein the first and the second optical character recognition process against the image data object are used for redundant cross validation of the target critical data element identifier or the corresponding alias of the target critical data element identifier in the image data object.

18. The computer implemented method of claim 13, wherein the output data object is stored as a reliability metric data value associated with a validation of source data object lineage.

19. The computer implemented method of claim 18, wherein the reliability metric data value is inserted into corresponding reliability metadata of a report data object generated based on the corresponding image data objects.

20. A non-transitory computer readable medium storing machine interpretable instructions, which when executed by a processor, cause the processor to execute a method for automated source data object lineage tracking, the computer implemented method comprising:
maintaining a knowledge base data structure storing structured primary transaction data;
receiving an image data object representing data to be inserted into the knowledge base data structure;
generating one or more language model prompts, each language model prompt corresponding to a critical data element identifier, an associated critical data element identifier alias, or a critical data element value; and
executing the one or more language model prompts using one or more language models against the image data object to generate structured data objects to be inserted as extended metadata corresponding to the image data object in the knowledge base data structure.
